(19) United States
(12) Patent Application Publication
(10) Pub. No.: US 2010/0094863 A1
(43) Pub. Date: Apr. 15, 2010

(54) INTENTIONALITY MATCHING

(76) Inventors: Branton Kenton-Dau, Christchurch (NZ); Martin Burley, Christchurch (NZ)

Correspondence Address: GRAY ROBINSON, P.A., P.O. Box 2328, FT. LAUDERDALE, FL, 33303-9998, US

(21) Appl. No.: 12/450,141

(22) PCT Filed: Mar. 12, 2008
(86) PCT No.: PCT/NZ2008/000051

§ 371 Date: Sep. 11, 2009

(30) Foreign Application Priority Data
Mar. 12, 2007 (NZ) 553759
Jun. 29, 2007 (NZ) 556196
Jun. 29, 2007 (NZ) 556197
Jan. 25, 2008 (NZ) 565425

(51) Int. Cl. G06F 17/30; G06F 15/18; G06N 5/02; G06Q 10/00

(52) U.S. Cl. 707/722; 707/737; 706/12; 706/54; 707/749; 705/10

(57) ABSTRACT

A series of methods, systems and objects are disclosed permitting a person to judge their intentionality against a particular object or set of objects. This is achieved through the use of an object profile of a choice point including at least a set of discrete markers representing attributes of users; a set of discrete buckets associated with each discrete marker representing the attribute values of users; and a count associated with each bucket representing the value weighting of the choice point for that bucket, which object profile is stored on an electronic storage device.

### FIELD OF THE INVENTION

The present invention relates to intentionality matching methods, systems and objects. More particularly, the present invention relates to intentionality matching between people's intentions and objects that they might associate with.

### BACKGROUND OF THE INVENTION

There are increasingly moves to correlate actions taken by entities (whether corporate or individuals) to a sense of self or culture of those entities. A sense of self or culture of an entity (whether corporate or an individual) can be quantified and reduced to a profile of ratings for that entity. In this regard, reference is had to another patent application by the applicants, namely PCT/NZ2006/000241 (published as PCT publication no. WO 2007/032692), which is hereby fully incorporated in its entirety by reference. A sense of self or culture of a corporate entity or individual profile can be compared to profiles of other corporate entities or individuals. The more closely that the profiles correlate, the more of a shared identity they have. While it is possible to compare profiles between people or corporate entities, that patent publication only deals with profiles between entities.

There are many attempts to determine the relevance of a particular object or a personal choice to a person. These have considerable commercial value in that they can, for example, be used in search engines to locate resources that would be relevant to a user searching using a search engine. Examples include, the use of keyword matching to display web pages (as used in meta-tags in html pages, for example). Unfortunately, keyword-based searching provides only some results relevant to a user as keywords tend to be chosen by web page authors or other resource authors or compilers and are therefore prone to human error. Others, such as U.S. Pat. No. 7,254,547, identify a user and set a series of constraints and conditions for the choice of information to be displayed. Another example includes, for example, the site www.amazon.com, that currently offers previous visitors new products based on what was viewed and purchased previously. Unfortunately, this requires that the user be identified thereby raising privacy issues and in addition, the results are often not relevant to the user. What would be useful is to correlate and compare an entity's profile to an outcome or object that does not require that the individual be identified.

It is therefore an object of the present invention to correlate an entity's profile with a choice point or to at least provide the public with a useful choice.

### SUMMARY OF THE INVENTION

In a first aspect, the present invention provides an object profile of a choice point including at least:
a) a set of discrete markers representing attributes of users;
b) a set of discrete buckets associated with each discrete marker representing the attribute values of users; and
c) a count associated with each bucket representing the value weighting of the choice point for that bucket,
   which object profile is stored on an electronic storage device.

In a second aspect, the present invention provides an idealised genome map for each user of an identical structure as the object profiles in the first aspect of the invention, including at least:
a) a set of discrete markers representing attributes of users;
b) a set of discrete buckets associated with each discrete marker representing the attribute values of users; and
c) a count associated with each bucket representing the value weighting of the choice point for that bucket, which object profile is stored on an electronic storage device.

In a third aspect, the present invention provides a method for populating an idealised genome map of the second aspect of the invention including at least the steps of:
a) retrieving a choice point selection made by the user via an input device;
b) retrieving a pre-stored object profile for the choice, point from an electronic storage device, which object profile includes at least a set of discrete attributes and associated discrete values;
c) retrieving the idealised genome map for the user from an electronic storage device if it exists or creating it if it does not exist, which idealised genome map includes at least a set of discrete markers associated with a set of discrete buckets and a count associated with each bucket;
d) incrementing each count in the idealised genome map for each attribute and value in the object profile and matching marker and bucket in the idealised genome map; and
e) storing the idealised genome map on said electronic storage device.

In a fourth aspect, the present invention provides a method of determining a correlation total for a relationship between an entity's profile and a choice point object profile of the first aspect of the invention including at least the following steps:
a) retrieving a choice point identification from a user via an input device;
b) retrieving a pre-stored user profile for the user from an electronic storage device, which user profile includes at least a set of discrete attributes and associated discrete values;
c) retrieving a pre-stored object profile for the choice point identification from an electronic storage device, which object profile is as defined in the first aspect of the invention;
d) calculating a correlation total by summing each count in the object profile for each attribute and value in the user profile and matching marker and bucket in the object profile; and
e) storing the correlation total on an electronic storage device.

In a fifth aspect, the present invention provides a method for populating a choice point object profile of the first aspect of the invention including at least the steps of:
a) providing a seed user with a series of choices on a display device;
b) retrieving a choice election made by the point from the seed user via an input device;
c) creating an association with the choice election and a choice point identification;
d) retrieving a pre-stored user profile for the user from an electronic storage device, which user profile includes at least a set of discrete attributes and associated discrete values;
e) retrieving the choice point object profile from an electronic storage device for the identification if it exists or creating it if it does not exist, which object profile includes at least a set of discrete markers associated with a set of discrete buckets and a count associated with each bucket;
f) incrementing each count in the object profile for each attribute and value in the user profile and matching marker and bucket in the object profile; and
g) storing the object profile on said electronic storage device.

In a sixth aspect, the present invention provides a method of determining the meaningfulness of a first set of one or more choice points to a second set of one or more choice points comprising:
a) Retrieving a set of Average Choice Point Scores from an electronic storage device;
b) Computing an overall Choice Point Set Score for said set of Choice Points by summing each Average Choice Point Score and dividing by the number of Average Choice Point Scores retrieved;
c) Comparing the selected Choice Point Set Score with other Choice Point Set Scores, wherein Quantifying the meaningfulness of the selected Choice points,
where a higher Choice Point Set Score indicates more meaningfulness.

In a seventh aspect, the present invention provides a method of establishing the relevance of a first set of one or more choice points to a second set of one or more other choice points comprising:
d) retrieving a first set of object profiles of the invention for the first set of choice points from an electronic storage device;
e) retrieving a second set of object profiles of the invention for the second set of choice points from an electronic storage device;
f) establishing the relevance of the Candidate Links to the Target. Link or Links, including at least the steps of:
   a. treating the Object Profiles of the Target Links as though they are Idealised Genome Maps, and obtaining an Idealised Genome for each Target Link against which the Basic Relevance Scores of the Candidate Links can be calculated; and
   b. calculating the Basic Relevance Scores of the Candidate Links for the Target Links,

n an eighth aspect, the present invention provides a system for determining a correlation total for a relationship between an entity's profile and a choice point's object profile of the first aspect of the invention including at least the following:
a) an input device for retrieving a choice point identification from a user;
b) an electronic storage device containing at least a pre-stored user profile for the user, which user profile includes at least a set of discrete attributes and associated discrete values;
c) an electronic storage device containing at least a pre-stored object profile for the choice point identification as defined in the first aspect of the invention;
d) a calculating device for determining a correlation total by summing each count in the object profile for each attribute and value in the user profile and matching marker and bucket in the object profile; and
e) an electronic storage device for storing the correlation total.

In a ninth aspect, the present invention provides a system for determining the meaningfulness of a selected choice point object profile of the first aspect of the invention comprising:
a) An electronic storage device containing at least a set of Choice Point Scores from an electronic storage device;
b) Computing device to compute an Average Points Score for said set of Choice Points by summing each Choice Point's Score and dividing by the number of Choice Point Scores retrieved;
c) Comparing device to compute a comparison result of the selected Choice Point Score versus the Average Points Score, wherein Quantifying the meaningfulness of the selected Choice point, where a Choice Point Score that exceeds the Average Points Score indicates more meaningfulness to Users.

In a tenth aspect, the present invention provides a computer program storage medium comprising a computer program that carries out any of the methods of the invention.

### BRIEF DESCRIPTION OF THE DRAWINGS

The invention is described below with reference to the figures, in which:

FIG. 1 is a flow chart of the sequence in which the invention is applied to create or update the profile for a particular product or other object;

FIG. 2 is a flow chart of the sequence in which the invention is applied to create or update the profile for a particular product or other object;

FIG. 3 is a flow chart of the sequence in which the invention is applied to calculate a Relevance Score or Scores as a result of a match or search request by or on behalf or a particular user;

FIG. 4 is a flow chart showing how to determine relevant tags for an advertisement;

FIG. 5 is a flow chart showing how to determine where to place an advertisement;

FIG. 6 is a flow chart showing how a profile for a link may be created or updated;

FIG. 7 is a flow chart showing how to assess the relevance of a Candidate Link or Links to a Target Link or Links in order to optimise a website;

FIG. 8 is a flow chart showing the set-up processes involved in the use of the invention as a game in any mode;

FIGS. 9A and 9B are a composite flow chart showing the calculation and update processes involved in the use of the invention as a game in any mode; and

FIGS. 10A and 10B are a composite flow chart showing the use of the invention to assess and enhance computer and online games.

### DETAILED DESCRIPTION OF THE INVENTION

### Definitions

In this specification, the following terms have the definition given after the dash:
Seed User—a person whose choices are used in the initial ‘seeding’ of the Object Profiles;
Entity—any human entity, whether individually or corporately;
User—any person who interacts with choice points once their Object Profiles have been seeded;
Choice Point—a Choice Point is a point of user interaction, which may include, for example, a material product, service, search term, URL or other unique resource link, picture, an environment state, a game state, advertisement, a supplied answer to a question or any other such object, such that a User may become associated with the Choice Point as the result of his or her choice or choices;
Object Profile—each Choice Point has its own Object Profile. The Object Profile is a table which stores data, based on the Genomes of the Users interacting with the Choice Point;
Genome—a 7-digit number that encodes the User's intention, each digit being an independent value on a 1 to 5 scale, the score representing the strength of that facet of the User's intention;
Subjective Genome—a genome obtained through the User taking a survey;
Idealised Genome—a genome obtained from the Choice Points the User selects;
System User—a company or other organisation using the invention new systems incorporating choice points and/or assess and/or improve their existing products by implementing choice points; and
Environment—a defined universe in which a user can make choices. Environments, preferably also permit a user to interact with objects in the environment. Non-limiting examples include the Internet, an intranet, a shopping mall and a shop. Particularly preferred environments are those that are an artificially controlled user interaction space, such as those created by game engines and virtual reality creations.
User profile—a user profile defined in PCT/NZ2006/000241. More particularly in relation to the examples herein, the profile comprises a 5×7 grid of buckets and markers, respectively.
Input device—any device capable of capturing a user's input, including (but not limited to) a computer terminal, PDA (personal data assistant).

As stated above, in a first aspect, the present invention provides an object profile of a choice point including at least:
a) a set of discrete markers representing attributes of users;
b) a set of discrete buckets associated with each discrete marker representing the attribute values of users; and
c) a count associated with each bucket representing the value weighting of the choice point for that bucket,
   which object profile is stored on an electronic storage device.

Preferably, the choice point is selected from the group consisting of: a material product, service, search term, URL or other unique resource link, picture, an environment state, a game state, advertisement, and a user-supplied answer to a question.

In a preferred embodiment, there are at least 7 discrete markers. In one embodiment, there are at least 5 buckets per marker. In another embodiment, there are 10 buckets.

In a preferred embodiment, an object profile of the first aspect of the invention is a global object profile, wherein the values of each bucket of the global object profile are the sum of the values for that bucket for all the individual object profiles for all choice points in a given system.

In one embodiment, each profile (whether a user profile or an object profile) has a ‘genome’ containing seven ‘markers’. Each marker is a single digit from 1 to 5. These are scores reflecting the coherence of the user's purpose, values, and life focus. When a user becomes associated with an object, his or her markers are added to the total for the corresponding buckets in the Profile for the link.

In a second aspect, the present invention provides an idealised genome map for each user of an identical structure as the object profiles in the first aspect of the invention, including at least:
g) a set of discrete markers representing attributes of users;
h) a set of discrete buckets associated with each discrete marker representing the attribute values of users; and
i) a count associated with each bucket representing the value weighting of the choice point for that bucket, which object profile is stored on an electronic storage device.

In certain scenarios, some of the markers in an object profile are absent or additional markers are present, or that the order is jumbled. Therefore, in a preferred embodiment, unique tags are employed to permit the matching of markers in profiles with only an overlapping set of markers.

In a third aspect, the present invention provides a method for populating an idealised genome map of the second aspect of the invention including at least the steps of:
j) retrieving a choice point selection made by the user via an input device;
k) retrieving a pre-stored object profile for the choice point from an electronic storage device, which object profile includes at least a set of discrete attributes and associated discrete values;
l) retrieving the idealised genome map for the user from an electronic storage device if it exists or creating it if it does not exist, which idealised genome map includes at least a set of discrete markers associated with a set of discrete buckets and a count associated with each bucket;
m) incrementing each count in the idealised genome map for each attribute and value in the object profile and matching marker and bucket in the idealised-genome map; and
n) storing the idealised genome map on said electronic storage device.

In a fourth aspect, the present invention provides a method of determining a correlation total for a relationship between an entity's profile and a choice point object profile of the first aspect of the invention including at least the following steps:
a) retrieving a choice point identification from a user via an input device;
b) retrieving a pre-stored user profile for the user from an electronic storage device, which user profile includes at least a set of discrete attributes and associated discrete values;
c) retrieving a pre-stored object profile for the choice point identification from an electronic storage device, which object profile is as defined in the first aspect of the invention;
d) calculating a correlation total by summing each count in the object profile for each attribute and value in the user profile and matching marker and bucket in the object profile; and
e) storing the correlation total on an electronic storage device.

In one embodiment, the identification of choice point is obtained indirectly from the user by being associated with a choice made by the user in a user interface.

In another embodiment, the user and the storage device are at geographically separate locations connected by a data network. The user's profile, object profile and correlation total may be stored on discrete electronic storage devices.

In a preferred embodiment, the correlation total calculated between the entity and the choice point is compared with an expected correlation by calculating the correlation between the entity and a global object profile in order to establish a normalised correlation total between the entity and the choice point. The expected correlation is the average correlation between the entity and a random choice point.

In a fifth aspect, the present invention provides a method for populating a choice point object profile of the first aspect of the invention including at least the steps of:
a) providing a seed user with a series of choices on a display device;
b) retrieving a choice election made by the point from the seed user via an input device;
c) creating an association with the choice election and a choice point identification;
d) retrieving a pre-stored user profile for the user from an electronic storage device, which user profile includes at least a set of discrete attributes and associated discrete values;
e) retrieving the choice point object profile from an electronic storage device for the identification if it exists or creating it if it does not exist, which object profile includes at least a set of discrete markers associated with a set of discrete buckets and a count associated with each bucket;
f) incrementing each count in the object profile for each attribute and value in the user profile and matching marker and bucket in the object profile; and
g) storing the object profile on said electronic storage device.

Optionally, the process in the above aspect is repeated for any new seed user's interacting with said choice point.

In a preferred embodiment, the series of choices in a) are presented by way of URLs using an html-capable browser, wherein the choice points are related to URLs chosen by said seed user.

In a sixth aspect, the present invention provides a method of determining the meaningfulness of a first set of one or more choice points to a second set of one or more choice points comprising:
o). Retrieving a set of Average Choice Point Scores from an electronic storage device;
p) Computing an overall Choice Point Set Score for said set of Choice Points by summing each Average Choice Point Score and dividing by the number of Average Choice Point Scores retrieved;
q) Comparing the selected Choice Point Set Score with other Choice Point Set Scores, wherein Quantifying the meaningfulness of the selected Choice points,
where a higher Choice Point Set Score indicates more meaningfulness.

The result may be displayed on a display device or stored on an electronic storage device. Using this method, the meaningfulness of particular choice points can be compared by seeing which Choice Points have high or low Average Choice Point Scores. The ones that have high scores are more effective at training users to select based on their intention. Game designers, for example, can make use of these scores when deciding which details of their games to alter. Raising the Average Choice Point Scores for the individual Choice. Points in a game will also raise the Average Game Score for the game as a whole (the measure of its overall meaningfulness).

Therefore, in a seventh aspect, the present invention provides a method of establishing the relevance of a first set of one or more choice points to a second set of one or more other choice points comprising:
r) retrieving a first set of object profiles of the invention for the first set of choice points from an electronic storage device;
s) retrieving a second set of object profiles of the invention for the second set of choice points from an electronic storage device;
t) establishing the relevance of the Candidate Links to the Target Link or Links, including at least the steps of:
   a. treating the Object Profiles of the Target Links as though they are Idealised Genome Maps, and obtaining an Idealised Genome for each Target Link against which the Basic Relevance Scores of the Candidate Links can be calculated; and
   b. calculating the Basic Relevance Scores of the Candidate Links for the Target Links,

This aspect therefore establishes the Relevance Score of the Candidate Links to the Target Links.

In an eighth aspect, the present invention provides a system for determining a correlation total for a relationship between an entity's profile and a choice point's object profile of the first aspect of the invention including at least the following steps:
a) an input device for retrieving a choice point identification from a user;
b) an electronic storage device containing at least a pre-stored user profile for the user, which user profile includes at least a set of discrete attributes and associated discrete values;
c) an electronic storage device containing at least a pre-stored object profile for the choice point identification as defined in the first aspect of the invention;
d) a calculating device for determining a con-elation total by summing each count in the object profile for each attribute and value in the user profile and matching marker and bucket in the object profile; and
e) an electronic storage device for storing the correlation total.

In one embodiment, the input device further comprises an abstracted device of identifying a choice point in a user interface.

In a ninth aspect, the present invention provides a system for determining the meaningfulness of a selected choice point object profile of the first aspect of the invention comprising:
a) An electronic storage device containing at least a set of Choice Point Scores from an electronic storage device;
b) Computing device to compute an Average Points Score for said set of Choice Points by summing each Choice Point's Score and dividing by the number of Choice Point Scores retrieved;
c) Comparing device to compute a comparison result of the selected Choice Point Score versus the Average Points Score, wherein Quantifying the meaningfulness of the selected Choice point, where a Choice Point Score that exceeds the Average Points Score indicates more meaningfulness to Users.

In one embodiment, the system further includes a display device for displaying the comparison result. In another embodiment, the system further includes an electronic storage device for storing the comparison result.

In a tenth aspect, the present invention provides a computer program storage medium comprising a computer program that carries out any of the methods of the invention.

The methods and systems involved in the invention can generally be divided into set-up processes, calculation processes and feedback processes. These are described below. Any additional processes involved for specific uses are described separately thereafter.

The user profile may additionally comprise other identifying information, such as cookie identification information, IP address, or user name.

The object profile may additionally comprise other identifying information, such as human-readable information concerning the choice point, for example a URL or a unique identifier.

The electronic storage devices in this specification may conveniently be distributed across a network or located on a single machine. In a particularly preferred embodiment, the user and the electronic storage devices are at geographically separate locations connected by a data network. The user's profile, object profile and correlation total may be stored on discrete electronic storage devices.

One preferred embodiment of the invention applies object tags to advertisements. Conveniently, a supplement to web pages that includes the ability to place ads may be deployed as:
1. A downloadable extension to the user's web browser.
2. A web page reconfigured to include the supplement when a user clicks on a link on the original web page.

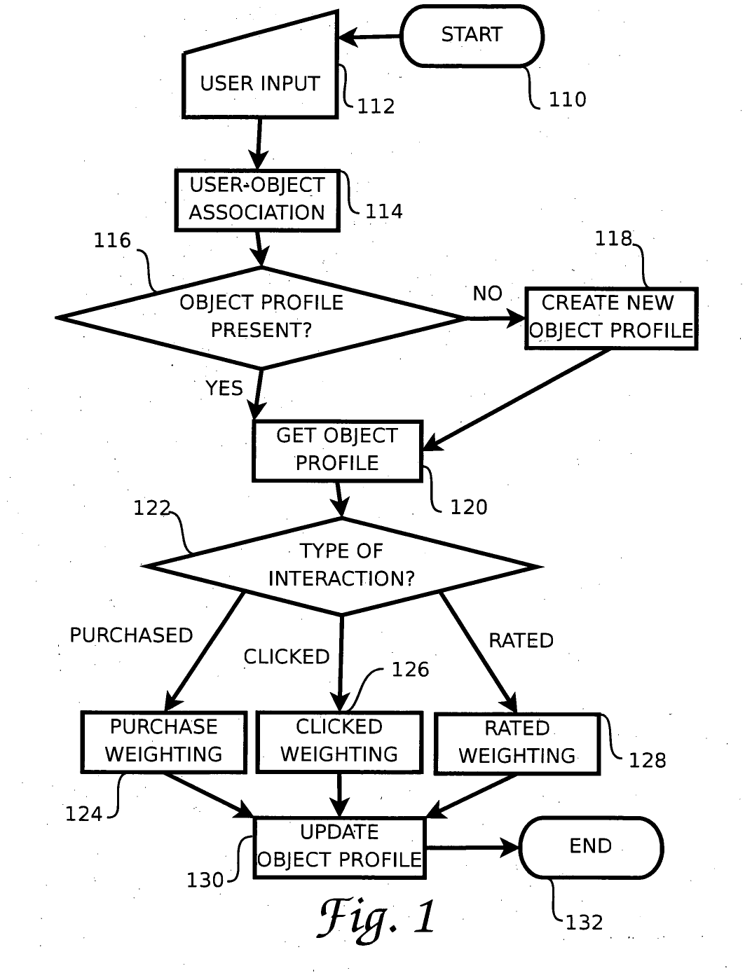

In order for the supplement to be more acceptable to users, additional material, including the ability for users to ‘mark up’ web pages is preferably provided in addition to the object profiles of the present invention. FIG. 1. Potential view of the web page supplement as it may look at the top of a webpage.

### 1. A Downloadable Extension

A user can download software required to add the supplement to their web pages via their browser. The software enables the browser to reconfigure the web page viewed by the user with the additional material the supplement provides. If required, the supplement can be provided by a different server than the server providing the web page.

In order for the supplement to be able to display content, including advertising relevant to the users, the user may be required to take a survey in order to create the 7 digit ‘genome’ user profile.

2. A Re-Configured Web-Page from a Link

An alternative method of displaying the supplement to a user is for the owner of the web page to include on the page a link. If the user clicks on the link a server provides the web page to the user with the supplemented material included.

If cookies or other methods, such as the user being logged into the website being visited, have not identified the user to the extent to which a user's 7 digit genome can be determined, then the user may also have to take a survey in order for a genome to be created for them before they can view the information provided by the supplement.

### Circling of Links on Web Page

The addition of the supplement to the web page also includes the option to mark up the web page directly through the circling of links that are determined by the teachings herein to be the most relevant links for the user. This service is another reason why the user would seek to use the technology.

This circling process takes place at the same time as providing the page supplement. If no data is available for the links on the web page then no links are circled.

### Tag Data Collection

Some aspects of the present invention require URLs to have tags associated with them. Further, these tags are most useful when the user profile that has added the tag is known.

There are two methods by which the present invention can obtain these tags:
1. The user can add tags directly from the page supplement provided by invention.
2. The user can import tags from another application, such as a social bookmarking site like del.icio.us. In this case the teachings herein permit the addition of the user's genome to the tags imported. When a page is found by a search query, it can add a tag to the page.

Preferably, the back-end calculations are implemented through a computer program written in a basic language so as to allow the calculations and results to be easily converted for any platform, including making the results available over the Internet for any standard platform, the program furthermore fulfilling the important requirement of obtaining data from and providing data to online websites, and providing near-instant computation of the calculations involved, which would not be possible using a non-programmatic method of implementing the invention.

It will be appreciated that where, the word “link” is used the term may include, but is not limited to, URLs, products, advertisements, and other classes of online content with which users can be determined to be either associated or not associated.

A convenient starting point for the invention is to select the Choice Point. These can be any states that a user can reach as the result of the user's choice or choices.

Each Choice point is given an Object Profile, which in a preferred embodiment is a 5×0.7 grid. The Object Profile is initially empty, but will have data added to it in the seeding process.

User profiles can conveniently be obtained by seeding a subjective genome. Seed Users have Subjective Genomes (obtained froth using a survey such as that described in PCT Application Number PCT/NZ2006/000241) or Idealised Genomes (obtained from interacting in other intention-enabled environments according to the invention), and have demonstrated consistency of intention as measured by their User. Consistency Score (calculated based on those other environments incorporating Choice Points).

In an alternative embodiment, the Subjective Genomes can be derived using other information, for example a genome based on demographic information about the individuals. This could, for example, show how unique an environment experience is for users of different ages, or of income levels, or whatever other demographic is used to calculate the individuals' genomes.

One way to populate a Choice Point Object Profile is to add a Seed User's Subjective Genome to the Object Profile for any Choice Point they choose in the course of progressing through the Choice Point environment. In one embodiment, the buckets (cells) of the Object Profile corresponding to the Seed User's Subjective Genome are incremented. However, it is envisaged that the buckets may be designed to be altered in a non-linear fashion, for example logarithmic or polynomial.

Users are conveniently assigned Idealised Genome Maps. In one embodiment, these are 5×7 grids using the same data structure as an Object Profile. Data is added to them when the User reaches a Choice Point. A User's Idealised Genome is given by the bucket in the User's Idealised Genome Map with the highest count, for each marker.

When data is added to a User's Idealised Genome Map, the Basic Relevance Ratios from the Object Profile are added, not the counts. This means that all Object Profiles add the same amount to each marker of a user's Idealised Genome Map (when the user interacts with the corresponding Choice Points), however well-seeded the Object Profile is.

In one embodiment, Object Profiles are updated in real-time even in a multi-User environment.

A Global Object Profile is conveniently defined as a grid. The counts for each bucket in the grid are the total of the counts for the corresponding bucket for the Object Profiles of all the Choice Points. The Global Object Profile for a particular environment is recalculated whenever data is added to any of the Object Profiles for the Choice Points in that environment.

The Basic Relevance Score of a particular Choice Point is defined as the total count for the buckets in the Choice Point's Object Profile that correspond to a User's Idealised Genome, divided by the average total count, where:

Average total count=(total count per marker)*(number of markers)/(number of buckets per marker)

The Basic Relevance Score is calculated based on whether the total count for the user's Genome buckets is higher than an expected total count. If the Object Profile for a particular Choice Point has double the count in its buckets compared to another Object Profile with an otherwise identical Object Profile, then it will also have double the expected total count, so the Basic Relevance Score will be the same in either case.

The Basic Relevance Score may also conveniently be calculated using Relevance Ratios. In some instances, this can be more computationally efficient. The Relevance Ratio for each bucket is:

Relevance Ratio=(number of buckets)*(count for bucket)/(total count per marker)*(number of markers)

The Basic Relevance Score for the Choice Point is then simply the sum of the Relevance Ratios for the buckets in the Choice Point's Object Profile that correspond to the User's Idealised Genome.

The Expected Relevance Score is the Basic Relevance Score that the Global Object has for a particular user.

A Normalised Relevance Score is the Basic Relevance Score of the Choice Point for the User, divided by the Expected Relevance Score for the User.

The invention may be used to model other people's profiles. The Modelling Relevance Score when a User is trying to emulate a particular person or type of person is calculated in exactly the same way as for the Normilised Relevance Score, except that the target person's genome is used in the calculations, rather than the User's own genome.

In use, a User is being compared to a target person's inner identity (intention), rather than their external behaviour or characteristics. Once the target person's profile is determined, other users can model themselves against them in any environment, whether in a game, a business environment or in any other context.

Conveniently, the user's Idealised Genome Map is not updated when modelling another person to enable the user's genome to remains pure (based on their choices made when being themselves, rather than when modelling a target person).

A Maximising Score for a Choice Point is calculated as:

sum of (bucket count*(bucket number−1/total number of buckets per marker−1))/total count

The User Maximising Score is the sum of the Maximising Scores for the objects the user chooses, divided by the sum of the highest Maximising Scores available for selection in each round.

The User Consistency Score is the average of the Normalised Relevance Scores for the Choice Points the User selects.

The User Modelling Consistency Score is the average of the Modelling Relevance Scores for the Choice Points the User selects.

In one embodiment, the User receives instant feedback, preferably on a display device, on his or her choices. It is envisaged that such feedback will assist Users to improve their consistency of intention, maximise their strength of intention, or model a target person's intention (as appropriate).

The AES is the average of all the User Consistency Scores obtained by Users of the environment.

The Modelling Environment Score for a particular target person or genome and a particular environment is the average of all the User Modelling Consistency Scores obtained by Users trying to emulate the target person or genome in that particular environment.

The Maximising Environment Score for a particular environment is the average of all the User Maximising Scores obtained by users in that environment.

The ACPS (Average Choice Point Score) is the average of all the Normalised Relevance Scores obtained by Users of the environment, based on that Choice Point alone.

The Environment Points a User receives for a particular environment may be calculated as:

Consistency Environment Points=User Consistency Score*j*Average Environment Score or

Modelling Environment Points=Modelling Consistency Score*k*Modelling Environment Score

Maximising Environment Points=User Maximising Score*l
where j, k and l are constants.

The Average Environment Points for a particular environment may be calculated as:

Average Environment Points for consistency-based environments=j*(Average Environment Scorê2) or

Average Environment Points for intention-modelling environments=k*(Modelling Environment Scorê2)

Average Environment Points for intention-maximising environments=l*Maximising Environment Score
where j, k and l are constants.

A User's Total Environment Points of a particular type is simply the sum of the User's Environment Points from all environments of that type that the User has been evaluated in.

Intention Rating is a measure of the current quality of a User's intention, based on its consistency (as measured by their IES) and its strength. Intention Rating is calculated as:

Intention Rating=Standardised User Consistency Score×Genome Rating

where

Standardised PCS=User Consistency Score/Average Environment Score for environment

and

Genome Rating=the sum of the digits in the User's Idealised Genome.

### Feedback Processes

In one embodiment, sandboxing is used as a way of determining which Users are consistently selecting Choice Points that their intention (as represented by their Idealised Genomes) predicts they will select. This acts as a quality control filter when updating the Object Profiles of the Choice Points. (Both sandboxed and non-sandboxed Users have their Idealised Genome Maps updated when they reach a Choice Point.)

Conveniently, a User is sandboxed when first registered. He or she becomes non-sandboxed when his or her User Consistency Score is greater thin or equal to a pre-entrance threshold. He or she then becomes sandboxed again when his or her User Consistency Score drops below a drop-out threshold. In a preferred embodiment, the drop-out threshold is less than the entrance threshold.

It should be noted that the specific values for system settings (such as the sandbox thresholds described above) can be altered according to the needs and requirements of the particular environment within which the invention is being applied.

In order to prevent any one User from skewing the Object Profiles, in the event that that User interacts with the environment multiple times, in one embodiment, the invention provides that when a User reaches a Choice Point, the Object Profile and the a check is made of a hierarchical list of a pre-determined number of most recent Users to have added data to that Object Profile. The User's Idealised Genome Map is only updated if the User is not on the list. If the User is in the list of recent Users, he is moved back to first place in the list, and no data is added to the Object Profile or the Idealised Genome Map.

In one embodiment, when a User reaches a Choice Point, if the User is non-sandboxed and the environment is being used in Consistency mode or Maximising mode, rather than Modelling mode, his or her Idealised Genome is added to the Object Profile for the Choice Point, and the Relevance Ratios for the Global Object Profile, multiplied by the number of markers and divided by the number of buckets per marker, are subtracted from the Object Profile for the Choice Point.

In one embodiment, when a User reaches a Choice Point, if the environment is being used in Consistency mode or Maximising mode, rather than Modelling mode, the Relevance Ratios for the Choice Point's Object Profile are added to the User's Idealised Genome Map, and the Relevance Ratios for the Global Object Profile are subtracted from the User's Idealised Genome Map.

When a User reaches a Choice Point, the Normalised Relevance Score for the Choice Point may be conveniently added to the User's Cached Normalised Scores List. The User's Consistency Score is then re-calculated. The recalculated score displayed to the User immediately, giving the User instant feedback on how effectively he or she is acting in line with his or her intention. At the end of the environment interaction, the User's Consistency Environment Points and Consistency Total Points are displayed to the User.

When a User reaches a Choice Point, the Modelling Relevance Score for the Choice Point is added to the User's Cached Modelling Scores List. The User's Modelling Consistency Score is then re-calculated. The recalculated score is displayed to the User immediately, giving the User instant feedback on how effectively he or she is emulating the target person or genome. At the end of the environment, the User's Modelling Environment Points and Modelling Total Points are displayed to the User.

When a User reaches a Choice Point, the Maximising Score for the Choice Point is added to the User's Cached Maximising Scores List. The User's Maximising Score is then re-calculated. The recalculated score is displayed to the User immediately, giving the User instant feedback on how effectively he or she is maximising the strength of their intention. At the end of the environment, the User's Maximising Environment Points and Maximising Total Points are displayed to the User.

The Average Environment Score (AES) provides a measure of how meaningful an environment or a subset of choice points in an environment is. If the environment receives a high Average Environment Score, then it means that Users often tend to make choices based on their own intention. If the environment receives a low Average Environment Score, Users' choices within that environment are only rarely guided by their intention. Therefore, a environment with a high AES provides a more individual experience than a environment with a low AES.

The Average Choice Point Scores (ACPS) for the individual Choice Points within the environment can be used to map out which aspects of the environment are more or less meaningful to individual Users. This can be used to modify a environment and increase its AES, by replacing Choice Points that have low ACPS with ones that have higher ACPS, where possible. Environment designers can also enhance their environments by using the Average Environment Score, at the design stage, by selecting design alternatives that produce a higher Average Environment Score in testing over other alternatives.

### PREFERRED APPLICATION EMBODIMENTS OF THE INVENTION

The invention his application in a range of situations, in which relevance may be defined in, different ways. In particular, a choice point can be said to be relevant to a user if: (a) the relative numbers of users similar to the current user who are associated with the choice point is sufficiently high (for example, when a user is seeking to find a social club where the members are similar to him), (b) the relative frequency with which users like the current user are associated with the choice point compared with other objects is high (for example, when a user is seeking to find a useful piece information on a particular topic), or (c) the relative frequency with which users like the current user are associated with the choice point compared with other users of that object is high (for example, when a user is seeking to find a website that is particularly interesting for people like him).

In the case of businesses, since individuals' decisions are guided by their personal purposes, values, and life focuses, the ability to quantify the relevance of particular choice points, such as products or other objects to particular individuals based on the individuals' personal purposes, values, and life focuses can provide businesses with an advantage in enhancing their competitive position. The calculation of the Relevance Score as described, as described in PCT/NZ2006/000241, has the advantage of producing results that can concord with an interaction-based model of personal and cultural identity and potentially provide a more accurate quantitative measure of these aspects than previous methods have achieved. Using the teachings herein, the results can also be applied to choice points.

This increased accuracy allows specific recommendations to be given to businesses and individuals regarding the relevance of particular products or other objects to those individuals, increasing the potential that the businesses can successfully market their products or other objects to those individuals and thereby improve their commercial performance. For example, a product that appeals to customers who value personal relationships will be marketed differently to a product or other object that appeals to customers who value gaining the respect of others.

In the case of individuals, the invention provides a device for individuals to effectively search a wide array of products or other objects for an appropriate choice, by examining the Relevance Scores of those products or objects with that individual. More generally, estimation of the likely subjective value an individual will gain from a particular product or object is made possible through the comparison of Relevance Scores for similar products or objects.

Use of the present invention, due to the nature of the Relevance Scores, and the coupling of the individual's intentionality to technology assisting the individual enhances the ability of an individual to develop a clearer and stronger sense of self, and to find products and other objects that are in line with his or her purpose, values and life focus, leading to more successful and satisfying relationships and experiences.

Furthermore, it should be noted that the invention could be implemented so that the object profiles for products or objects within a particular universe are held and accessed separately from those in other universes, and that this could enhance the applicability of the invention (for example, by restricting searches on a supermarket's homepage to products from that supermarket).

It will be appreciated that all reports mentioned could be provided in a variety of forms, electronic or otherwise, and delivery methods, both on-line and off-line.

It will further be appreciated that the electronic use of an algorithm to perform the calculations as described above allows the calculations to be performed near-instantaneously. This enables the profiles of widely used products or other objects to reflect the ongoing preferences of a large user group in a timely manner, and enables a single individual's profile to be assigned to a wide array of products or other objects in a timely manner. This is particularly important in cases such as supermarkets, where many customers are each purchasing many items every day.

In one embodiment, the above methods and systems have application in the following non-limiting applications:
a) Predicting instances of cancer—In this case the choice point would be the illness, or potentially different choice points for various cancer types. Individuals with the cancer would add their data to the cancer object. Other individuals would evaluate their genome against the cancer objects to evaluate their likelihood of contracting the illness. This application is useful in cancer cases which demonstrate a significant placebo effect during clinical trials;
b) Prediction of auto insurance claims—the choice point would be an auto insurance claim, or potentially different choice points for different claim types. Individuals with the claims would add their data to the claim object. Other individuals would evaluate their genome against the claim objects to evaluate their likelihood of making a claim;
c) Improving product and content recommendation on the web—as many products or content links would have object profiles. The User genome would be compared against each profile and the objects with the highest normalized relevance scores would be recommended to the user. Objects and links without profiles would be recommended after profiles with high normalized relevance scores for the user and before profiles with low relevance scores for the user;
d) Improving search algorithms—the user genome would be compared against each search link with an object profile. The ranking of the objects based upon the normalized relevance score would be compared to the ranking of the objects using the non-improved search algorithm and genome-based ranking factored into the non-improved ranking according to various weighting criteria specific to the specific search environment;
e) Improving cross and upselling opportunities in organisations to existing client base—Each product or service would be assigned an object profile based upon user genome interaction. The product or service with the highest normalized relevance score would be upsold to the client;
f) Providing more relevant advertising, on the web, and mobile phones—The user genome would be compared against the object profile of each ad and the objects with the highest normalized relevance scores would be recommended to the user;
g) Matching people on a dating site—The users with closet match in their genome rating would be recommended to each other;
h) Finding people on a social network—The users with closet match in their genome rating would be recommended to each other;
i) recommending books—The user genome would be compared against the object profile of each book and the objects with the highest normalized relevance scores would be recommended to the use;
j) identifying the genome of music—The user genome would be compared against the object profile of each music track and the objects with the highest normalized relevance scores would be recommended to the user;
k) finding the right investments using a new form of values/ethical investing—The companies with closet match in their genome rating with an investor would be recommended to the investor;
l) finding the right job—The companies with closet match in their genome rating with a job seeker would be recommended to them;
m) finding the school that suits a student best—The school with closet match in the student's genome rating with a potential pupil would be recommended to them;
n) find the right mentor, advisor, lawyer, doctor—The right mentor, advisor, lawyer, doctor with closet match in their genome rating would be recommended to the potential client;
o) find the right director—The candidate with closet match in their genome rating with a company would be recommended to them;
p) get good trades people—The trades people with closet match in their genome rating would be recommended to the potential client;
q) buy games that a purchaser will like—The user genome would be compared against the object profile of each game and the objects with the highest normalized relevance scores would be recommended to the user;
r) assemble gamers likely to enjoy playing together—The gamer with closet match in their genome rating would be recommended to a user;
s) select a hotel for a user that people like the user have stayed in before—The user genome would be compared against the object profile of each hotel and the objects with the highest normalized relevance scores would be recommended to the user;
t) book tickets with an airline for a user—the user genome would be compared against the object profile of each airline and the objects with the highest normalized relevance scores would be recommended to the user;
u) book travel to places that user is likely to enjoy—the user genome would be compared against the object profile of each travel destination and the objects with the highest normalized relevance scores would be recommended to the user;
v) find a suitable place to live—The user genome would be compared against the object profile of each geographic location and the objects with the highest normalized relevance scores would be recommended to the user;
w) find the right apartment block for a user—the user genome would be compared against the object profile of each apartment and the objects with the highest normalized relevance scores would be recommended to the user; and
x) rent a good film from the video store. The user genome would be compared against the object profile of each video and the objects with the highest normalized relevance scores would be recommended to the user.

### EXAMPLES

The invention is described below with reference to non-limiting examples:

### Set-up Processes

### Choke Point Selection

The initial step in the use of the invention is to select the Choice Point. These can be any environment states that a User can reach as the result of the User's choice or choices.

Each Choice Point is given an Object Profile, which is a 5×7 grid. The Object Profile is initially empty, but will have data added to it in the seeding process.

Examples of Choice Points: reaching a particular location, finding a particular object in an environment, choosing to undertake a particular mission.

An object profile comprises a 5×7 grid with 7 markers and 5 buckets. The markers are representative of the following attributes:
a) System Coherence
b) System Autopoiesis
c) Focus Score (Area 1)
d) Focus Score (Area 2)
e) Focus Score (Area 3)
f) Focus Score (Area 4)
g) Focus Score (Area 5)

### Obtaining Subjective Genomes

The Object Profiles are seeded when Seed Users enter an environment for the first time. The Seed Users have pre-determined Subjective Genomes (obtained from using a survey such as that described in PCT Application Number PCT/NZ2006/000241) or Idealised Genomes (obtained from other environments where object profiles have been seeded by the user's their choice points), and have demonstrated consistency of intention as measured by their User Consistency Score (calculated based on those other games). When a Seed User logs in to the game, his User ID is sent to the Master Database. The Master Database finds the Seed User's Subjective Genome and sends it back to the game

Examples of Subjective Genome: 1334523, 4533523, 5555555, 1111111.

### Seeding Object Profiles

When a Seed User reaches a Choice Point, his or her Subjective Genome is added to the Object Profile for the Choice Point. The buckets (cells) of the Object Profile corresponding to the Seed User's Subjective Genome are incremented.

### Example: of Seeding an Object Profile:

Note: The columns in the tables below are labelled M1 to M7. These labels correspond to the markers on which the Genomes are based. The rows in the tables are labelled B1 to B5. These labels correspond to the value of the Genome markers, each of which is an integer value between 1 and 5.

If a particular Choice Point has the following Object Profile:

| | M1 | M2 | M3 | M4 | M5 | M6 | M7 |
|---|---|---|---|---|---|---|---|
| B1 | 6 | 0 | 0 | 2 | 0 | 4 | 0 |
| B2 | 0 | 1 | 2 | 1 | 3 | 0 | 1 |
| B3 | 0 | 2 | 2 | 3 | 0 | 1 | 0 |
| B4 | 0 | 3 | 2 | 0 | 1 | 1 | 2 |
| B5 | 0 | 0 | 0 | 0 | 2 | 0 | 3 |

And a Seed User with a Subjective Genome of 5435524 reaches this Choice Point, the Object Profile is updated and becomes:

### Choice Point Selection

| | M1 | M2 | M3 | M4 | M5 | M6 | M7 |
|---|---|---|---|---|---|---|---|
| B1 | 6 | 0 | 0 | 2 | 0 | 4 | 0 |
| B2 | 0 | 1 | 2 | 1 | 3 | 1 | 1 |
| B3 | 0 | 2 | 3 | 3 | 0 | 1 | 0 |
| B4 | 0 | 4 | 2 | 0 | 1 | 1 | 3 |
| B5 | 1 | 0 | 0 | 1 | 3 | 0 | 3 |

### Calculation Processes

### Idealised Genome Maps

Users using the game in the post set-up stage have Idealised Genome Maps. These are 5×7 grids. Data is added to them when the User reaches a Choice Point.

Example of an Idealised Genome Map:

| | M1 | M2 | M3 | M4 | M5 | M6 | M7 |
|---|---|---|---|---|---|---|---|
| B1 | 3 | 2 | 2 | 0 | 5 | 0 | 0 |
| B2 | 2 | 1 | 0 | 2 | 0 | 0 | 1 |
| B3 | 1 | 3 | 3 | 0 | 0 | 1 | 0 |
| B4 | 0 | 0 | 0 | 1 | 1 | 1 | 2 |
| B5 | 0 | 0 | 1 | 3 | 0 | 4 | 3 |

### Calculating Idealised Genome

A User's Idealised Genome is given by the bucket in the User's Idealised Genome Map with the highest count, for each marker.

Example: If a User has the above Idealised Genome Map, the Use's Idealised Genome is 1335155.

### Global Object Profile

The Global Object Profile is a 5×7 grid. The counts for each bucket in the grid are the total of the counts for the corresponding bucket for the Object Profiles of all the Choice Points in the game.

### Example:

If we have just two Choice Points in the game, with the following Object Profiles:

| | M1 | M2 | M3 | M4 | M5 | M6 | M7 |
|---|---|---|---|---|---|---|---|
| | CP 1 | | | | | | |
| B1 | 6 | 0 | 0 | 2 | 0 | 4 | 0 |
| B2 | 0 | 1 | 2 | 1 | 3 | 0 | 1 |
| B3 | 0 | 2 | 2 | 3 | 0 | 1 | 0 |
| B4 | 0 | 3 | 2 | 0 | 1 | 1 | 2 |
| B5 | 0 | 0 | 0 | 0 | 2 | 0 | 3 |
| | CP 2 | | | | | | |
| B1 | 2 | 2 | 5 | 6 | 1 | 0 | 0 |
| B2 | 2 | 3 | 5 | 2 | 2 | 0 | 3 |
| B3 | 3 | 2 | 0 | 0 | 3 | 0 | 3 |
| B4 | 2 | 1 | 2 | 4 | 3 | 0 | 3 |
| B5 | 3 | 4 | 0 | 0 | 3 | 12 | 3 |

Then the Global Object Profile would be:

| Global Object | M1 | M2 | M3 | M4 | M5 | M6 | M7 |
|---|---|---|---|---|---|---|---|
| B1 | 8 | 2 | 5 | 8 | 1 | 4 | 0 |
| B2 | 2 | 4 | 7 | 3 | 5 | 0 | 4 |
| B3 | 3 | 4 | 2 | 3 | 3 | 1 | 3 |
| B4 | 2 | 4 | 4 | 4 | 4 | 1 | 5 |
| B5 | 3 | 4 | 0 | 0 | 5 | 12 | 6 |

The Global Object Profile for a particular game is recalculated whenever data is added to any of the Object Profiles for the Choice Points in that game.

### Calculating Basic Relevance Scores

The Basic Relevance Score of a particular Choice Point is the total count for the buckets in the Choice Point's Object Profile that correspond to the User's Idealised Genome, divided by the average total count, where

Average total count=(total count per marker)*(number of markers)/(number of buckets per marker)

Example: If a Choice Point has the'following Object Profile:

| | M1 | M2 | M3 | M4 | M5 | M6 | M7 |
|---|---|---|---|---|---|---|---|
| B1 | 6 | 0 | 0 | 2 | 0 | 4 | 0 |
| B2 | 0 | 1 | 2 | 1 | 3 | 0 | 1 |
| B3 | 0 | 2 | 2 | 3 | 0 | 1 | 0 |
| B4 | 0 | 3 | 2 | 0 | 1 | 1 | 2 |
| B5 | 0 | 0 | 0 | 0 | 2 | 0 | 3 |

Then Average total count=(total count per marker)*(number of markers)/(number of buckets)=6*7/5=8.4

For a User with an Idealised Genome of 1333335, the Choice Point would have a Basic Relevance Score of (6+2+2+3+0+1+3)/8.4

=17/8.4

=2.02

On the other hand, for a User with an Idealised Genome of 3224323 the Choice Point would have a Basic Relevance Score of (0+1+2+0+0+0+0)/8.4

=3/8.4
=0.36

### Calculating Relevance Ratios

To improve calculation speed, the system can calculate the Basic Relevance Score using Relevance Ratios. The Relevance Ratio for each bucket is:

Relevance Ratio=(number of buckets)*(count for bucket)/(total count per marker)*(number of markers)

The Basic Relevance Score for the Choice Point is then simply the sum of the Relevance Ratios for the buckets in the Choice Point's Object Profile that correspond to the User's Idealised Genome.

For the Object Profile above, the Relevance Ratios are:

| | M1 | M2 | M3 | M4 | M5 | M6 | M7 |
|---|---|---|---|---|---|---|---|
| B1 | 0.71 | 0.00 | 0.00 | 0.24 | 0.00 | 0.48 | 0:00 |
| B2 | 0.00 | 0.12 | 0.24 | 0.12 | 0.36 | 0.00 | 0.12 |
| B3 | 0.00 | 0.24 | 0.24 | 0.36 | 0.00 | 0.12 | 0.00 |
| B4 | 0.00 | 0.36 | 0.24 | 0.00 | 0.12 | 0.12 | 0.24 |
| B5 | 0.00 | 0.00 | 0.00 | 0.00 | 0.24 | 0.00 | 0.36 |

As above, for a User with an Idealised Genome of 1333335 the Choice Point would have a Basic Relevance Score of (0.71+0.24+0.24+0.36+0.00+0.12+0.36)=2.03

As above, for a User with an Idealised Genome of 3224323 the Choice Point would have a Basic Relevance Score of (0.00+0.12+0.24+0.00+0.00+0.00+0.00)=0.36

(Differences from Earlier Results Due to Rounding)

### Calculating Expected Relevance Scores

The Expected Relevance Score is the Basic Relevance Score that the Global Object has for a particular User.

Example: If the Global Object Profile has the following counts:

| | M1 | M2 | M3 | M4 | M5 | M6 | M7 |
|---|---|---|---|---|---|---|---|
| B1 | 6 | 0 | 0 | 2 | 0 | 4 | 0 |
| B2 | 0 | 1 | 2 | 1 | 3 | 0 | 1 |
| B3 | 0 | 2 | 2 | 3 | 0 | 1 | 0 |
| B4 | 0 | 3 | 2 | 0 | 1 | 1 | 2 |
| B5 | 0 | 0 | 0 | 0 | 2 | 0 | 3 |

The Relevance Ratios for the Global Object are:

| | M1 | M2 | M3 | M4 | M5 | M6 | M7 |
|---|---|---|---|---|---|---|---|
| B1 | 0.71 | 0.00 | 0.00 | 0.24 | 0.00 | 0.48 | 0.00 |
| B2 | 0.00 | 0.12 | 0.24 | 0.12 | 0.36 | 0.00 | 0.12 |
| B3 | 0.00 | 0.24 | 0.24 | 0.36 | 0.00 | 0.12 | 0.00 |
| B4 | 0.00 | 0.36 | 0.24 | 0.00 | 0.12 | 0.12 | 0.24 |
| B5 | 0.00 | 0.00 | 0.00 | 0.00 | 0.24 | 0.00 | 0.36 |

And for a User with an Idealised Genome of 1333335, the Global Object would have a Basic Relevance Score of (0.71+0.24+0.24+0.36+0.00+0.12+0.36)=2.03, (just as for a URL with the same Object Profile), so the User's Expected Relevance Score is 2.03

### Calculating Normalised Relevance Scores

The Normalised Relevance Score is the Basic Relevance Score of the Choice Point for the User, divided by the Expected Relevance Score for the User.

Example: If the Basic Relevance Score of a particular Choice Point for a particular User is 1.68, and the Expected Relevance Score for that User is 1.20, then the Normalised Relevance Score of that Choice Point for that User is 1.40

### Calculating Modelling Relevance Scores

The Modelling Relevance Score when a User is trying to emulate a particular person or type of person is calculated in exactly the same way as for the Normalised Relevance Score, except that the target person's genome is used in the calculations, rather than the User's own genome.

Example: If a User who has an Idealised Genome of 1413122 is trying to emulate a target person with a genome of 4324345, then the Normalised Relevance Scores are calculated based on the 4324345 genome, and the result is the Modelling Relevance Score.

### Calculating Maximising Scores

The Maximising Score for a Choice Point is calculated as sum of (bucket count*(bucket number−1/total number of buckets per marker−1))/total count

### Example:

If the Choice Point has the following Object Profile:

| | M1 | M2 | M3 | M4 | M5 | M6 | M7 |
|---|---|---|---|---|---|---|---|
| B1 | 6 | 0 | 0 | 2 | 0 | 4 | 0 |
| B2 | 0 | 1 | 2 | 1 | 3 | 0 | 1 |
| B3 | 0 | 2 | 2 | 3 | 0 | 1 | 0 |
| B4 | 0 | 3 | 2 | 0 | 1 | 1 | 2 |
| B5 | 0 | 0 | 0 | 0 | 2 | 0 | 3 |

Then the Maximising Score for the Choice Point is:

$$\frac{( \begin{matrix}( \frac{6 * ( 1 - 1 )}{( 5 - 1 )} ) + ( \frac{1 * ( 2 - 1 )}{( 5 - 1 )} ) + ( \frac{2 * ( 3 - 1 )}{( 5 - 1 )} ) + ( \frac{3 * ( 4 - 1 )}{( 5 - 1 )} ) + \\ ( \frac{2 * ( 2 - 1 )}{( 5 - 1 )} ) + ( \frac{2 * ( 3 - 1 )}{( 5 - 1 )} ) + ( \frac{2 * ( 4 - 1 )}{( 5 - 1 )} ) + ( \frac{2 * ( 1 - 1 )}{( 5 - 1 )} ) + \\ ( \frac{1 * ( 2 - 1 )}{( 5 - 1 )} ) + ( \frac{3 * ( 3 - 1 )}{( 5 - 1 )} ) + ( \frac{3 * ( 2 - 1 )}{( 5 - 1 )} ) + ( \frac{1 * ( 4 - 1 )}{( 5 - 1 )} ) + \\ ( \frac{2 * ( 5 - 1 )}{( 5 - 1 )} ) + ( \frac{4 * ( 1 - 1 )}{( 5 - 1 )} ) + ( \frac{1 * ( 3 - 1 )}{( 5 - 1 )} ) + ( \frac{1 * ( 4 - 1 )}{( 5 - 1 )} ) + \\ ( \frac{1 * ( 2 - 1 )}{( 5 - 1 )} ) + ( \frac{2 * ( 4 - 1 )}{( 5 - 1 )} ) + ( \frac{3 * ( 5 - 1 )}{( 5 - 1 )} )\end{matrix} )}{42} = \frac{( \begin{matrix}0 + 0.25 + 1 + 2.25 + 0.5 + 1 + 1.5 + \\ 0 + 0.25 + 1.5 + 0.75 + 0.75 + \\ 2 + 0 + 0.5 + 0.75 + 0.25 + 1.5 + 3\end{matrix} )}{42} = \frac{17.75}{42} = 0.422 …$$

### Calculating User Maximising Scores

The User Maximising Score is the sum of the Maximising Scores for the objects the user chooses, divided by the sum of the highest Maximising Scores available for selection in each round.

### Example:

In a two-round game, if the Choice Points have the following Maximising Scores:

### Round 1

### Choice Point-Maximising Score

### CP1-1.5

### CP2-3.5

### CP3-0.5

### CP4-1.0

### Round 2

### Choice Point-Maximising Score

### CP1-0.5

### CP2-2.5

### CP3-1

### CP4-1.5

And a User chooses CP1 in Round 1 and CP2 in Round 2; then the User Maximising Score is (1.5+2.5)/(3.5+2.5)=4/6=67%

### Calculating User Consistency Scores

The User Consistency Score is the average of the Normalised Relevance Scores for the Choice Points the User selects

Example: If the User selects Choice Points with Normalised Relevance Scores of 1, 2 and 3; the User Consistency Score is ((1+2+3)/3)=2

### Calculating User Modelling Consistency Scores

The User Modelling Consistency Score is the average of the Modelling Relevance Scores for the Choice Points the User selects

Example: If the User selects Choice Points with Modelling Relevance Scores of 0.5, 1 and 3, the User Modelling Consistency Score is ((0.5+1+3)/3)=1.5

### Calculating Average Game Score

The AGS is the average of all the User Consistency Scores obtained by Users of the game.

Example: If User 1 has a User Consistency Score of 1, User 2 has a PCS of 2, and User 3 has a PCS of 6, then the Average Game Score is ((1+2+6)/3)=3

### Calculating Modelling Game Score

The Modelling Game Score for a particular target person or genome and a particular game is the average of all the User Modelling Consistency Scores obtained by Users trying to emulate the target person or genome in that particular game.

Example: If Users 1, 2 and 3 all try to emulate Tony Blair in a particular game, and achieve User Modelling Consistency Scores of 0.25, 0.5, and 0.75, then the Modelling Game Score is ((0.25+0.5+0.75)/3)=0.5

Tony Blair does not need to have played the particular game being played by a player in order for the player to try to play the game ‘as though they are Tony Blair’. (Tony Blair's genome could have been calculated based on a different game, a survey, or other ways.)

### Calculating Maximising Game Score

The Maximising Game Score for a particular game is the average of all the User Maximising Scores obtained by Users playing that game.

Example: If Users 1, 2 and 3 achieve User Maximising Scores of 1.25, 1.0, and 0.75, for a particular game, then the Maximising Game Score is ((1.25+1+0.75)/3)=1

### Calculating Average Choice Point Score

The ACPS is the average of all the Normalised Relevance Scores obtained by Users of the game, based on that Choice Point alone.

Example: If Users 1, 2 and 3 select a Choice Point, and the Choice Point has a Normalised Relevance Score of 0.5 for User 1, 0.75 for User 2, and 1 for User 3, then the Average Choice Point Score is ((0.5+0.75+1)/3)=0.75

### Calculating Choice Point Set Score

The Choice Point Set Score is the average of the Average Choice Point Scores for a particular set of Choice Points.

Example: If the set comprises Choice Points A, B and C, and the Choice Points have Average Choice Point Scores of 1.2, 1.3, and 1.4 respectively, then the Choice Point Set Score is ((1.2+1.3+1.4)/3)=1.3

### Calculating Game Points

The Game Points a User receives for a particular game are calculated as:

Consistency Game Points=User Consistency Score*j*Average Game Score or

Modelling Game Points=Modelling Consistency Score*k*Modelling Game Score

Maximising Game Points=User Maximising Score*l

where j, k and l are constants.

### Example 1

If a User gained a User Consistency Score of 1.2 in a game with an Average Game Score of 1.5, and j=10, then the User scores 1.2*1.5*10=18 points

### Example 2

If a User gained a Modelling Consistency Score of 1.5 in a game with a Modelling Game Score of 13, and k=20, then the User scores 1.5*1.5*20=45 points

### Example 3

If a User gained a User Maximising Score of 2.1 in a game, and l=100, then the User scores 2.1*100=210 points

### Calculating Average Game Points

The Average Game Points for a particular game are calculated as:

Average Game Points for consistency-based games=j*(Average Game Score ̂2) or

Average Game Points for intention-modelling games=k*(Modelling Game Scorê2)

Average Game Points for intention-maximising games=l*Maximising Game Score

where j, k and l are constants.

### Example 1

For a consistency-based game with an Average Game Score of 1.5, and j=10, the Average Game Points score is 10*(1.5̂2)=225 points

### Example 2

For an intention-modelling game with a Modelling Game Score of 1.2, and k=20, the Average Game Points score is 20*(1.2̂ 2)=18.8 points

### Example 3

For an intention-maximising game with l=100 and a Maximising Game Score of 0.75, the Average Game Points score is 100*0.75=75

### Calculating Total Points

A User's Total Game Points of a particular type is simply the sum of the User's Game Points from all games of that type that the User has played.

Example: If a User gained 10 Consistency Game Points in one game, 20 Modelling Game Points in a second game, 30 Maximising Game Points in a third game, and 40 Consistency Game Points in a fourth game, then he or she has 50 Consistency Total Points, 20 Modelling Total Points, and 30 Maximising Total Points.

### Calculating Intention Rating

Intention Rating is a measure of the current quality of a User's intention, based on its consistency (as measured by their IES) and its strength. Intention Rating is calculated as

Intention Rating=Standardised User Consistency Score×Genome Rating

where

Standardised PCS=User Consistency Score/Average Game Score for game

and

Genome Rating=the sum of the digits in the User's Idealised Genome.

### Example:

A User gains a User Consistency Score of 1.54 on a game with an Average Game Score of 1.1. The User's Idealised Genome is 3453453.

The User's Intention Rating is:

$$\begin{matrix}( \frac{1.54}{1.1} ) * ( 3 + 4 + 5 + 3 + 4 + 5 + 3 ) = 1.4 * 27 \\ = 37.8\end{matrix}$$

With reference to FIG. 1, a flow chart of a sequence in which the invention applied to create or update the profile for a particular product or other object is depicted. The flowchart begins at 110. A user's input is received 112, which associates the user with an object 114. The object is arrived at through an active choice on the part of the user and is therefore is also a choice point, in this case the options are: to purchase an object, to click on an object or to rate an object.

The system queries at whether there is an object profile present for the object 116. If not, then a new object profile for the object is created 118 and it is stored on an electronic storage device (not shown). If an object profile is already present, then the object profile is accessed from an electronic storage device 120.

The object profile has the same structure as described above under the heading “Choice Point Selection”. The flow diverges at 122 depending on the choice made by a user.

If the user purchased the object, then a weighting of the buckets is undertaken 124. In particular, the user's buckets in the user's profile are weighted by 50% and added to the object's own buckets in its profile. As an alternative to this weighting, 1 may be added to the object's buckets corresponding to the user's profile buckets.

If the user merely clicked on the object, then a different weighting of the buckets is undertaken 126. In particular, the user's buckets in the user's profile are weighted by 10% and added to the object's own buckets in its profile. Again, as an alternative to the above weighting, 1 may be added to the object's buckets corresponding to the user's profile buckets instead.

If the user rated the object, then user's buckets are weighted 128 proportionately according to the rating given to the object. Again, as an alternative to the above weighting, 1 may be added to the object's buckets corresponding to the user's-profile buckets instead.

The weighted object profile is now updated 130 on the electronic storage device. The process ends at 132.

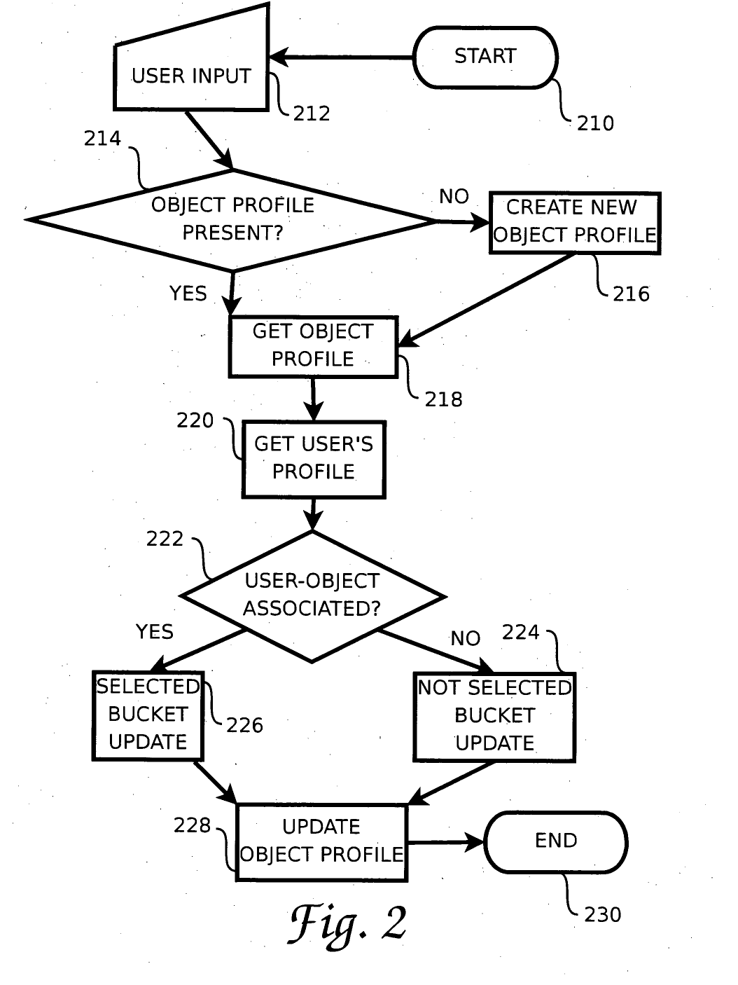

As an alternative, with reference to FIG. 2, a flow chart of the sequence in which the invention is applied to create or update the profile for a particular product or other object is depicted. The process begins at 210. A user has a choice to become associated with an object and the user's choice is treated as an input 212.

The presence of an object profile for the object on an electronic storage device is tested 214. If the object profile is not already existent, then a new object profile is created 216. The object profile has the same structure as described above under the heading “Choice Point Selection”. If the object profile does exist, then it is retrieved from the electronic storage device 218.

In this example, the user has a profile and it is stored on an electronic storage device (not shown). The user's profile is retrieved 220 from the electronic storage device. The user's input at 212 is tested at 222. If the user elected to become associated with the object, then 1 is added to the appropriate buckets on the selected side of each marker in the object's profile 226. Alternatively, if the user elected not to associate with the object, then 1 is added to the appropriate buckets on the not selected side of the marker in the object's profile.

The object's profile is then updated on the electronic storage device 228 and the process ends at 230.

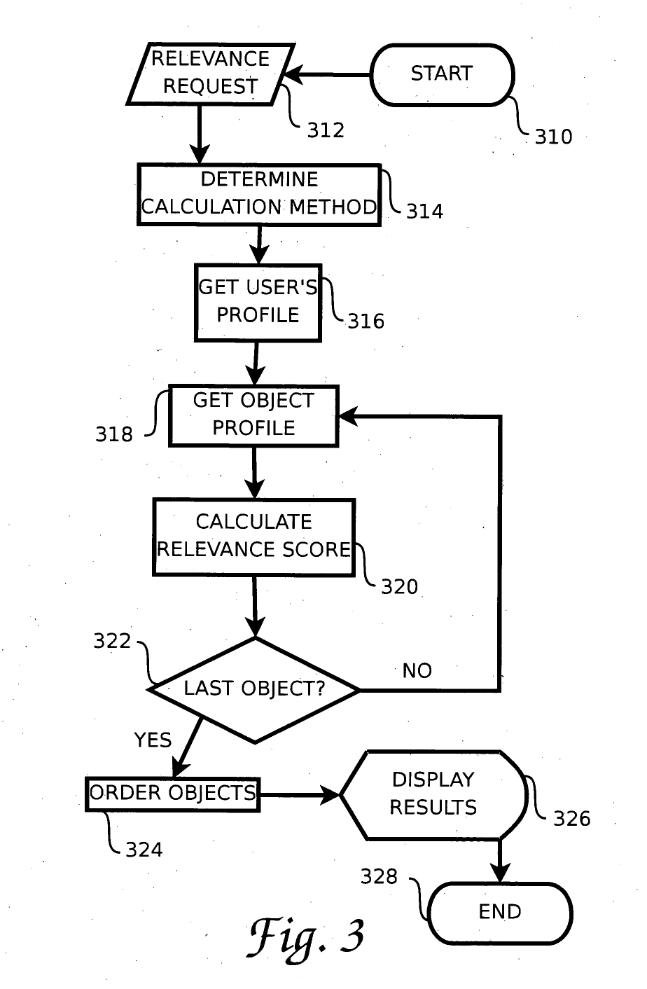

With reference to FIG. 3, the relevance of a match between a user and one or more objects is depicted. The process starts at 310. A relevance request is made for a particular user 312, who has an existing user profile on an electronic storage device (not shown) with reference to a set of one or more specified objects that also have object profiles stored on an electronic storage device (not shown). A relevant calculation method to be used is determined by the context of the relevance request 314. The user's profile is retrieved from the electronic storage device 316.

An object profile is retrieved from the electronic storage device 318 for the first item in the object set. A Relevance Score is calculated 320 according to an appropriate method for the object profile in the context of the user's profile. The current object in the set is tested to determine whether it is the last object in the set 322. If it is not, the process is repeated from 318 for the next item in the set until all items in the set have had a relevance score calculated for them. The set of objects is ordered according to their respective Relevance Scores for the user 324. The results are displayed in a manner appropriate to the context 326. The process ends at 328.

### Feedback Processes

### Sandboxing Procedure

Sandboxing is a way of determining which Users are consistently selecting Choice Points that their intention (as represented by their Idealised Genomes) predicts they will select. This acts as a quality control filter when updating the Object Profiles of the Choice Points. (Both sandboxed and non-sandboxed Users have their Idealised Genome Maps updated when they reach a Choice Point.)

A User is sandboxed when he first registers. He or she becomes non-sandboxed when his or her User Consistency Score is greater than or equal to 1.10. He or she then becomes sandboxed again when his or her User Consistency Score drops below 0.90.

Example: A User registers with the system. He is sandboxed. After selecting four Choice Points, his PCS is 1.05. He is still sandboxed. He then selects a fifth Choice Point, and his PCS increases to 1.15. He is now non-sandboxed. After selecting a further four Choice Points, his PCS has dropped to 0.95. He is still non-sandboxed. After selecting a tenth Choice Point, his PCS has dropped to 0.85. He is now sandboxed again, and, will remain so until his PCS increases above 1.10 again,

### Recent Users Check

In order to prevent any one from skewing the Object Profiles, in the event that that User plays the game multiple times, when a User reaches a Choice Point, the Object Profile and the User's Idealised Genome Map are only updated if the User is not among the 10 most recent Users to have added data to that Object Profile. If the User is in the list of recent Users, he is moved back to first place in the list, and no data is added to the Object Profile or the Idealised Genome Map.

### Object Profile Updating

When a User reaches a Choice Point, if the User is non-sandboxed and the game is being played in Consistency mode or Maximising mode, rather than Modelling mode, his or her Idealised Genome is added to the Object. Profile for the Choice Point, and the Relevance Ratios for the Global Object Profile, multiplied by the number of markers and divided by the number of buckets per marker, are subtracted from the Object Profile for the Choice Point.

### Example:

If the Object Profile for the Choice Point is:

| | M1 | M2 | M3 | M4 | M5 | M6 | M7 |
|---|---|---|---|---|---|---|---|
| B1 | 2 | 4 | 11 | 3 | 5 | 5 | 1 |
| B2 | 4 | 2 | 2 | 4 | 8 | 5 | 2 |
| B3 | 5 | 2 | 1 | 5 | 1 | 2 | 6 |
| B4 | 6 | 2 | 4 | 4 | 2 | 5 | 8 |
| B5 | 3 | 10 | 2 | 4 | 4 | 3 | 3 |

And the Relevance Ratios for the Global Object are:

| | M1 | M2 | M3 | M4 | M5 | M6 | M7 |
|---|---|---|---|---|---|---|---|
| B1 | 0.71 | 0.00 | 0.00 | 0.24 | 0.00 | 0.48 | 0.00 |
| B2 | 0.00 | 0.12 | 0.24 | 0.12 | 0.36 | 0.00 | 0.12 |
| B3 | 0.00 | 0.24 | 0.24 | 0.36 | 0.00 | 0.12 | 0.00 |
| B4 | 0.00 | 0.36 | 0.24 | 0.00 | 0.12 | 0.12 | 0.24 |
| B5 | 0.00 | 0.00 | 0.00 | 0.00 | 0.24 | 0.00 | 0.36 |

And the User's Idealised Genome is: 2342351

Then the updated Object Profile for the Choice Point is:

| | M1 | M2 | M3 | M4 | M5 | M6 | M7 |
|---|---|---|---|---|---|---|---|
| B1 | 1.00 | 4.00 | 11.00 | 2.67 | 5.00 | 4.33 | 2.00 |
| B2 | 5.00 | 1.83 | 1.67 | 4.83 | 7.50 | 5.00 | 1.83 |
| B3 | 5.00 | 2.67 | 0.67 | 4.50 | 2.00 | 1.83 | 6.00 |
| B4 | 6.00 | 1.50 | 4.67 | 4.00 | 1.83 | 4.83 | 7.67 |
| B5 | 3.00 | 10.00 | 2.00 | 4.00 | 3.67 | 4.00 | 2.50 |

### Idealised Genome Map Updating

When a User reaches a Choice Point, if the game is being played in Consistency mode or Maximising mode, rather than Modelling mode, the Relevance Ratios for the Choice Point's Object Profile are added to the User's Idealised Genome Map, and the Relevance Ratios for the Global Object Profile are subtracted from the User's Idealised Genome Map.

Example: If the User's Idealised Genome Map is:

| CP 2 | M1 | M2 | M3 | M4 | M5 | M6 | M7 |
|---|---|---|---|---|---|---|---|
| B1 | 2 | 2 | 5 | 6 | 1 | 0 | 0 |
| B2 | 2 | 3 | 5 | 2 | 2 | 0 | 3 |
| B3 | 3 | 2 | 0 | 0 | 3 | 0 | 3 |
| B4 | 2 | 1 | 2 | 4 | 3 | 0 | 3 |
| B5 | 3 | 4 | 0 | 0 | 3 | 12 | 3 |

And the Choice Point's Object Profile's Relevance Ratios are:

| | M1 | M2 | M3 | M4 | M5 | M6 | M7 |
|---|---|---|---|---|---|---|---|
| B1 | 0.04 | 0.14 | 0.39 | 0.10 | 0.18 | 0.15 | 0.07 |
| B2 | 0.18 | 0.07 | 0.06 | 0.17 | 0.27 | 0.18 | 0.07 |
| B3 | 0.18 | 0.10 | 0.02 | 0.16 | 0.07 | 0.07 | 0.21 |
| B4 | 0.21 | 0.05 | 0.17 | 0.14 | 0.07 | 0.17 | 0.27 |
| B5 | 0.11 | 0.36 | 0.07 | 0.14 | 0.13 | 0.14 | 0.09 |

And the Global Object's Relevance Ratios are:

| | M1 | M2 | M3 | M4 | M5 | M6 | M7 |
|---|---|---|---|---|---|---|---|
| B1 | 0.71 | 0.00 | 0.00 | 0.24 | 0.00 | 0.48 | 0.00 |
| B2 | 0.00 | 0.12 | 0.24 | 0.12 | 0.36 | 0.00 | 0.12 |
| B3 | 0.00 | 0.24 | 0.24 | 0.36 | 0.00 | 0.12 | 0.00 |
| B4 | 0.00 | 0.36 | 0.24 | 0.00 | 0.12 | 0.12 | 0.24 |
| B5 | 0.00 | 0.00 | 0.00 | 0.00 | 0.24 | 0.00 | 0.36 |

Then the User's updated Idealised Genome Map is:

| | M1 | M2 | M3 | M4 | M5 | M6 | M7 |
|---|---|---|---|---|---|---|---|
| B1 | 1.32 | 2.14 | 5.39 | 5.86 | 1.18 | 0.32 | 0.07 |
| B2 | 2.18 | 2.95 | 4.82 | 2.05 | 1.91 | 0.18 | 2.95 |
| B3 | 3.18 | 1.86 | 0.21 | 0.20 | 3.07 | 0.05 | 3.21 |
| B4 | 2.21 | 0.70 | 1.93 | 4.14 | 2.95 | 0.05 | 3.04 |
| B5 | 3.11 | 4.36 | 0.07 | 0.14 | 2.89 | 12.14 | 2.73 |

### Specific Processes: Creating a Scoring System for a Game

### User Scores Updating

i. Assessing the Consistency of a User's Intention

When a User reaches a Choice Point, the Normalised Relevance Score for the Choice Point is added to the User's Cached Normalised Scores List. The User's Consistency Score is then re-calculated. The recalculated score displayed to the User immediately, giving the User instant feedback on how effectively he or she is acting in line with his or her intention. At the end of the game, the User's Consistency Game Points and Consistency Total Points are displayed to the User.

ii. Assessing the Ability of a User to Emulate a Target Person or Genome

When a User reaches a Choice Point, the Modelling Relevance. Score for the Choice Point is added to the User's Cached Modelling Scores List. The User's Modelling Consistency Score is then re-calculated. The recalculated score is displayed to the User immediately, giving the User instant feedback on how effectively he or she is emulating the target person or genome. At the end of the game, the User's Modelling Game Points and Modelling Total Points are displayed to the User.

iii. Training a User to Maximise his or her Strength of Intention

When a User reaches a Choice Point, the Maximising Score for the Choice Point is added to the User's Cached Maximising Scores List. The User's Maximising Score is then re-calculated. The recalculated score is displayed to the User immediately, giving the User instant feedback on how effectively he or she is maximising the strength of their intention. At the end of the game, the User's Maximising Game Points and Maximising Total Points are displayed to the User.

### Specific Processes: Assessing the Meaningfulness of a Computer or Online Game

### Game Analysis

The Average Game Score provides a measure of how meaningful a game is. If the game receives a high Average Game Score, then it means that Users often tend to make choices based on their own intention. If the game receives a low Average Game Score, Users' choices within that game are only rarely guided by their intention Therefore, a game with a high AGS provides a more individual experience than a game with a low AGS.

### Specific Processes: Enhancing the Meaningfulness of a Computer or Game

### Choice Point Analysis

The Average Choice Point Scores for the individual Choice Points within the game can be used to map out which aspects of the game are more or less meaningful to individual Users. This can be used to modify a game and increase its AGS, by replacing Choice Points that have low ACPS with ones that have higher ACPS, where possible. Game designers can also enhance their games by using the Average Game Score at the design stage, by selecting design alternatives that produce a higher Average Game Score in testing over other alternatives.

### Application of the Invention in Advertising:

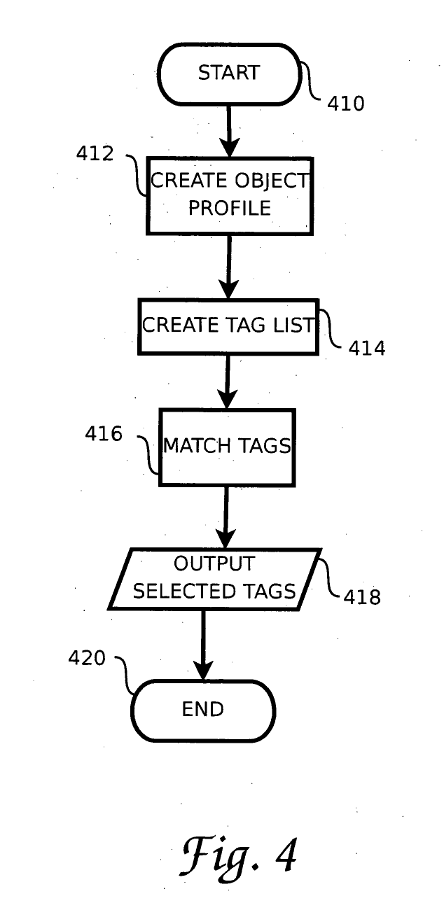

With reference to FIG. 4, a flow chart showing how to determine relevant tags fin an advertisement is depicted, wherein the process starts 410. An object profile is created 412 as exemplified above for a target link. A tag list is provided 414 that describes the advertisement for the product or service. A database of tags (not shown) is provided that has matching tags and object profiles. This database is used to match tags with the target link 416. The tags best matched with the target link are outputted 418 as descriptors for the advertisement.

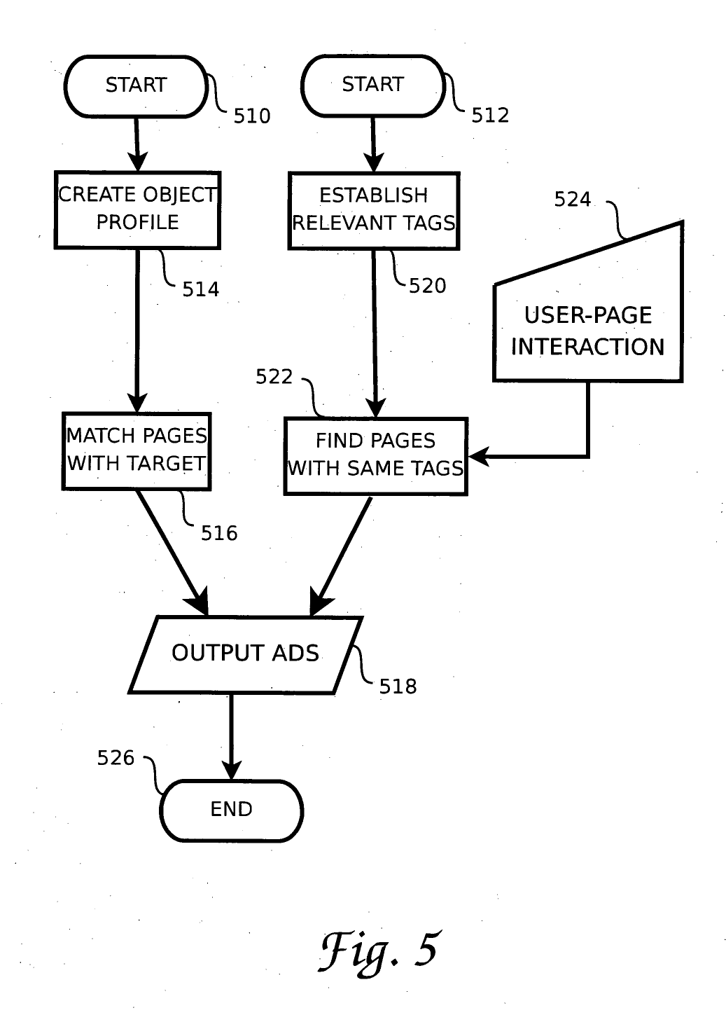

With reference to FIG. 5, is a flow chart showing how to determine where to place an advertisement is depicted beginning in two independent places, 510 and 512. An object profile is created 514 as described above for a target link for a product or service. A database of web page links matched to pages is employed to match pages with the Target Link 516. This information is passed onto the advertising output 518. Relevant tags for an advertisement are determined at 520. Pages with the same tags as the advertisement are located 522 with reference to pages marked up by users 524 which add user profiles to tags. Combining the outputs of 516 and 522, advertisements are then outputted 518 that best match the target link profile and where the page is described by the same tags as the advertisement. The process ends at 526.

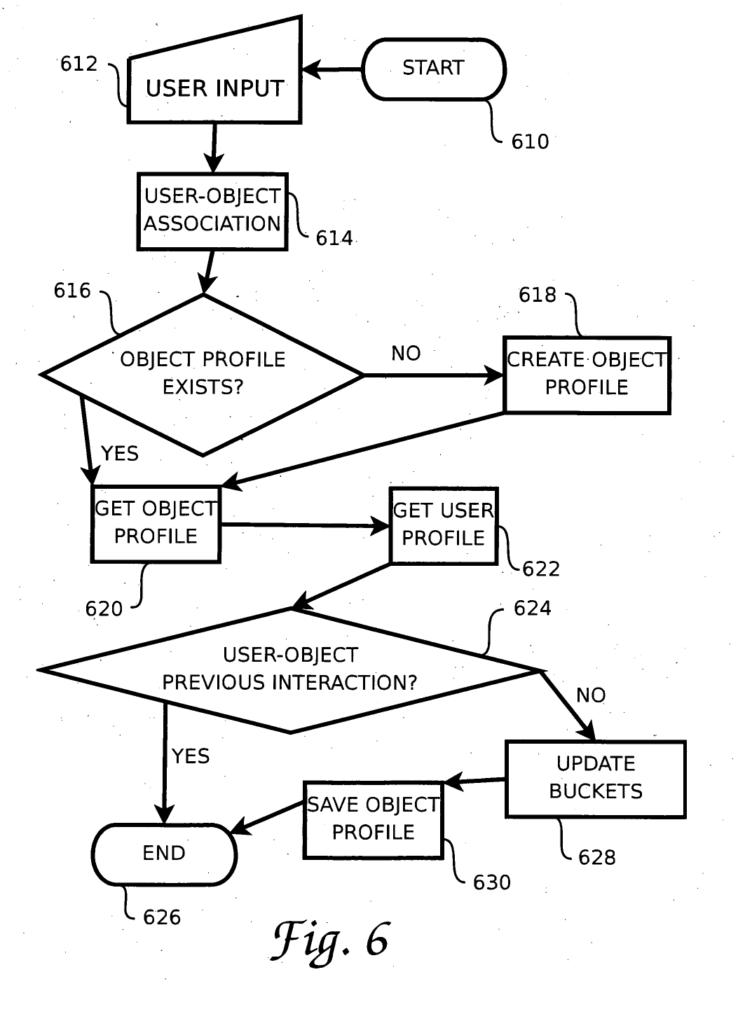

With reference to FIG. 6, a flow chart showing how a profile for a link may be created or updated is depicted. The process starts at 610. A user having a user profile stored on an electronic storage device elects to be become associated with a link 612 (e.g. by clicking on it). This is represented at 614. An electronic storage device (not shown) is queried to determine whether an object profile for the object exists 616. If it does not exist then a new object profile is created 618. Alternatively, is the object profile does exist, then it is retrieved 620 from said electronic storage device. The user's profile is retrieved 620 from the electronic storage device.

A database is queried to determine whether the user has previously been associated with the link in a predetermined previous period 624. If the user-link association is met then the process is ended 626. Otherwise, 1 is added to the buckets in the link's profile that correspond with the scores in the user's genome 628. The object's profile is updated on the electronic storage device 630 and the process ends 626.

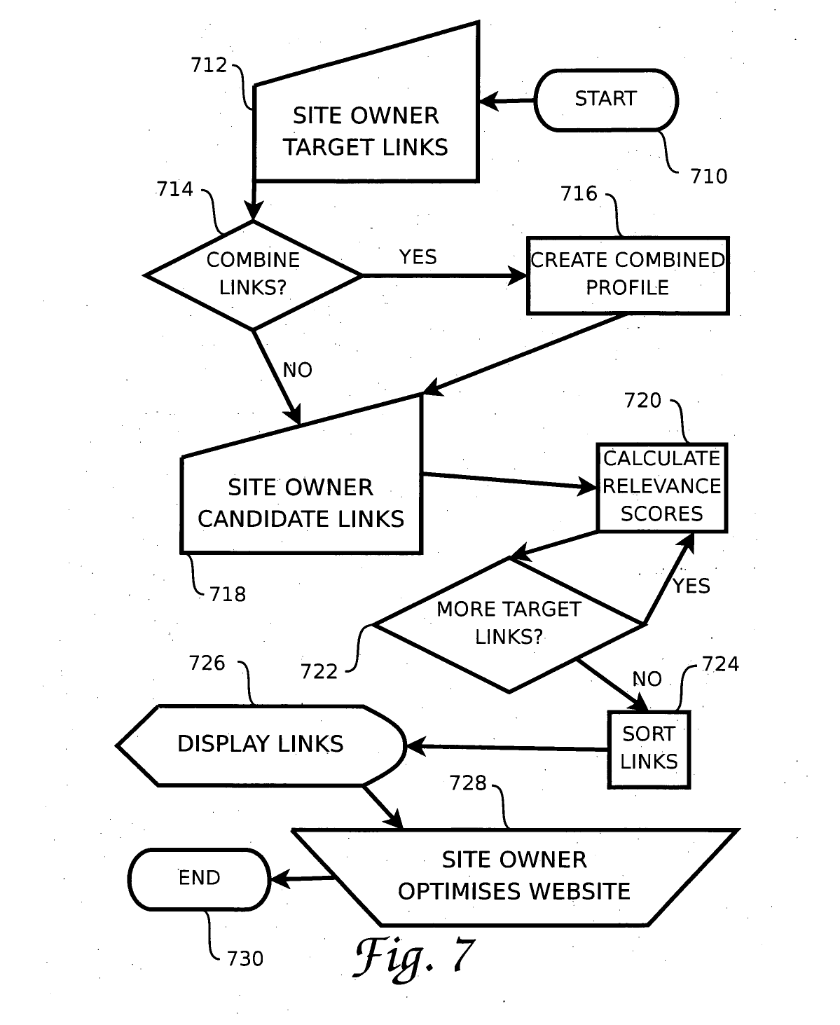

With reference to FIG. 7, a flow diagram showing a method for assessing the relevance of a Candidate Link or links to a target link or links in order to optimise a website is depicted. The flow begins at 710. The site owner designates one or more links as target links 712. A query is made as to whether there are several Target Links that should be combined into a single profile 714. If so, then a new combined object profile for the Target Links is created 716.

The site owner designates one or more Candidate Links 718 and the Candidate Links' Relevance Scores are calculated for the Target Link 720 as described above. A test is made to determine whether there are, additional Target Links to compare the Candidate Link against 722. If so, then the method continues from 720 until the there are no additional links. For each Target Link, the Candidate Links are listed in order of their Relevance Score for that Target Link (from most relevant to least relevant) 724. The sorted links are displayed to the site owner 726. The site owner optimises his website based on the results 728 (e.g. by making Candidate Links with high Relevance Scores more prominent, or by removing Candidate Links with low Relevance Scores, or advertising on candidate websites with the highest Relevance Scores. The method ends at 730.

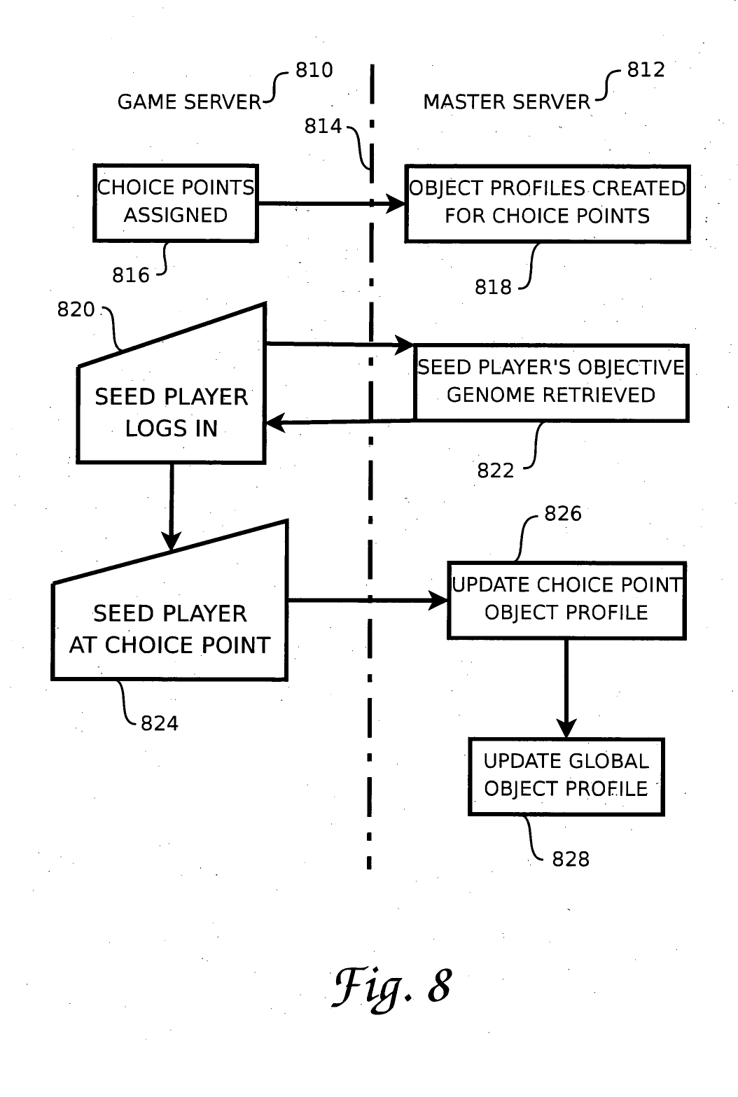

With reference to FIG. 8, a flow chart showing the set-up processes involved in the use of the invention as a game in any mode is depicted. The chart is divided into two parts showing a game server's functions 810 on the left and a master server's functions 812 on the right hand side separated by a broken line 814. The game server assigns Choice Points 816 and identifiers for these Choice Points are passed to the master server for the creation of object profiles for the choice points 818.

A seed player logs in to the game server 820. The seed player's credentials are passed to the master server, which retrieves the seed player's objective genome 822 and passes this back to the game server 810. Once the seed player is associated with a Choice Point 824 (as created at 816), the choice point identification is sent to the master server 812 where The Choice Point's object profile is updated 826 as described above. Additionally, the Global Object Profile is updated 828 as described above.

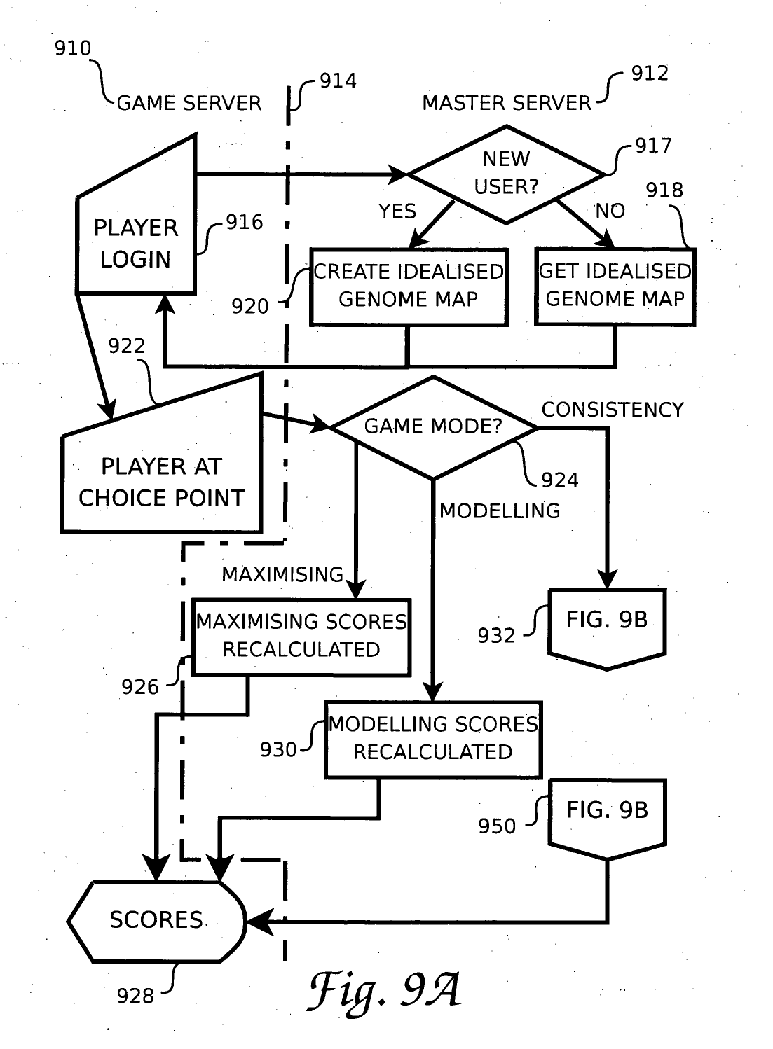

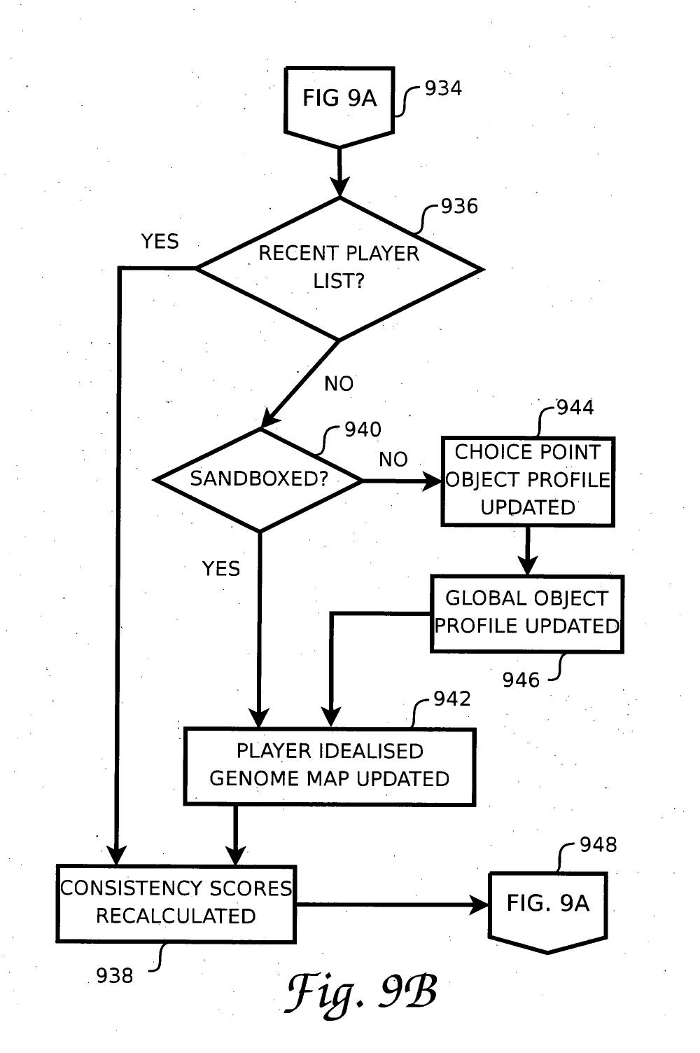

With reference to FIGS. 9A and 9B, a composite flow chart showing the calculation and update processes involved in the use of the invention as a game in any mode is depicted. As with FIG. 8, the functions are divided between a game server 910 and a master server 912, separated by a broken line 914. A player logs in 916 to the game server. The player's credentials are passed to the master server 912 and checked against a database (not shown) of existing player to determine whether the player is new 917. If the player exists in the database then the player's idealised genome map is retrieved from the database 918. If the player does not exist in the database, then an idealised Genome Map is created for the player 920 as described above. The idealised Genome Map is passed back to the game server 910.

Once the player associates with a Choice Point in the game 922, then a determination of game mode 924 is made on the master server 912 as to whether the game mode is maximising, modelling or consistency. If the game mode is maximising then the maximising scores are recalculated 926 as above and the recalculated scores are passed back to the game server 910 for display to the player 928. If the game mode is modelling then the modelling scores 930 are recalculated as above and the recalculated scores are passed back to the game server 910 for display to the user 928.

If the game mode is consistency then the flow diagram proceeds to 932, which correlates with 934 in FIG. 9B. A query is made as to whether the player is on the recent player's list for the associated choice point 936? If so, the consistency scores are recalculated as above 938. If not, then a further query is made as to whether the player is sandboxed 940. If so, then the player's idealised Genome Map is updated as above 942 and the consistency scores are recalculated 938.

If the player is not sandboxed then the choice point Object Profile is updated 944 and the global Object Profile is updated 946. The player's idealised Genome map is also updated 942 and the consistency scores recalculated 938. All of the possible paths all lead to 938 and this flows to 948, which correlates with 950 in FIG. 9A. As with earlier choices, the scores are transferred to the gaming server 910 and displayed 928.

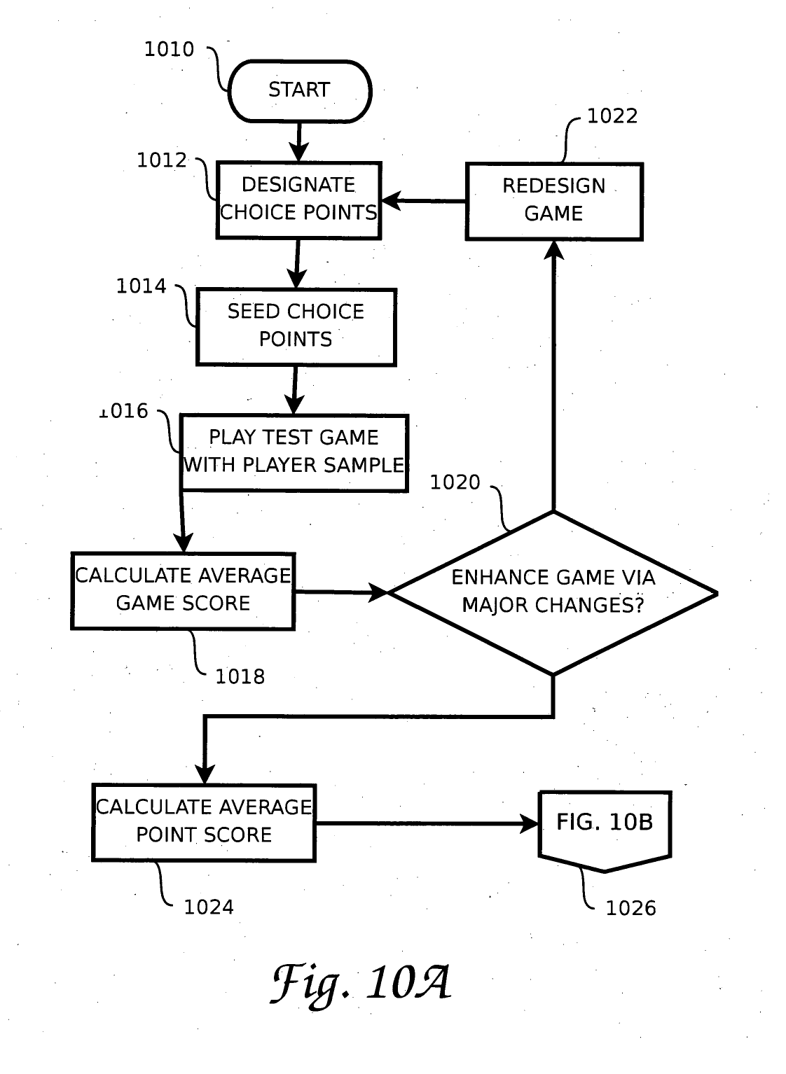

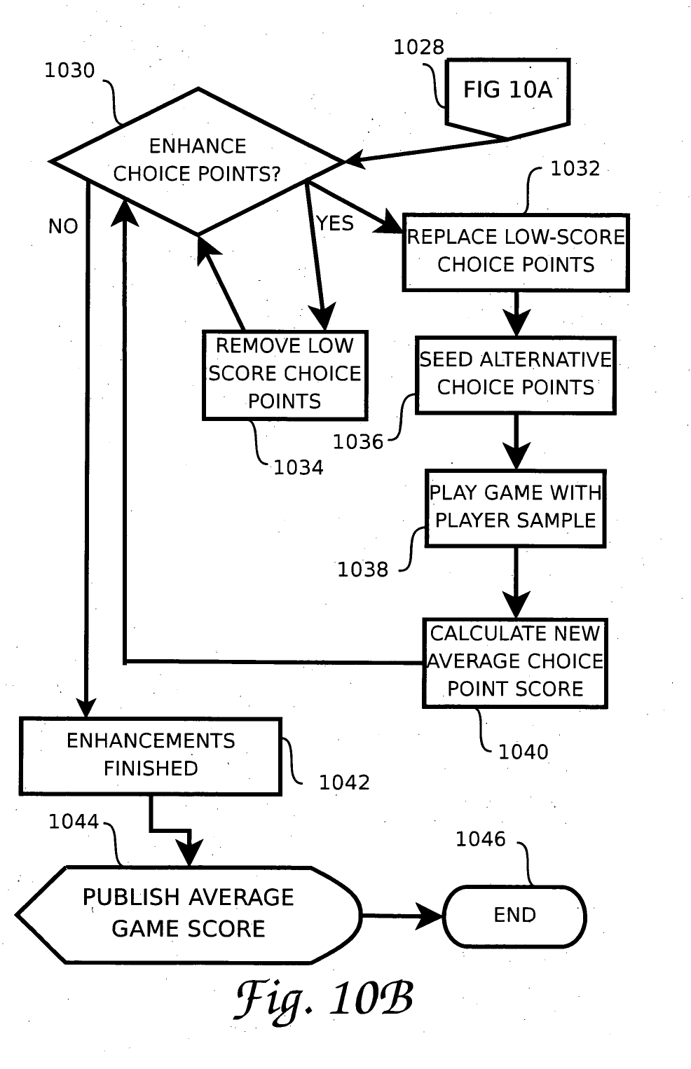

With reference to FIGS. 10A and 10B, a composite flow chart showing the use of the invention to assess and enhance computer and online games is depicted. The flow starts at 1010. Choice Points are designated in a game environment 1012. The Choice Points are seeded 1014 as described above. The game is then played with a sample of Players 1016. The average game score 1018 is calculated and decision is made whether to enhance the game-via major changes 1020. If so, the game is redesigned 1022 and iterated from the designation of choice points 1012. If not, the average Choice Point Score for all Choice Points in the game 1024 is calculated. The flow proceeds to 1026, which is equivalent to 1028 in FIG. 10B.

A decision is made as to whether to enhance choice points in the game. If it is decided to enhance the choice points then two possible paths may be adopted. The first one is to replace low-scoring Choice Points 1032. This is done if there are other potential Choice Points of a similar type, i.e. ones that can be inserted into the game as a replacement for the Choice Point or Choice Points being removed. The other option is to remove low scoring Choice Points altogether 1034, if no suitable replacement potential Choice Points are available. If the replacement option 1032 is selected then Alternative Choice Points are seeded 1036. The test game is then played with a player sample 1038 and a new Average Choice Point Score for all Choice Points is calculated 1040 and the process iterates back to whether to enhance choice points further 1030.

Once all enhancements are completed 1042, the Average Game Score when the game is launched is published 1044, which leads to the end of the flow 1046.

It will be appreciated that other embodiments of the present invention are possible. In particular, it will be appreciate by art-skilled workers that while some of the above examples relate to game engines, the relevance of web pages or other online information to a particular user of the system can be established by treating the web (or a subset of it, for example, the Flickr™ photo collection) in the same or a similar-fashion to a game, and the URLs, images, or other data as Choice Points. The Choice Points can be seeded as described above. The Normalised Relevance Scores of particular Choice Points for particular users can then be calculated. This information can be used to predict which data a user is likely to find relevant, enhancing the ability of browsers and websites to serve up relevant information to the user.

Additionally, the invention has application in raising employee personal effectiveness by feeding back to the their scores as they use the corporate intranet, where the accessing of the intranet pages are treated as Choice Points.

Yet another useful application of the invention is feedback on personal effectiveness of a library user based on the books they borrow at the library, where the act of taking a book out of the library is treated as a Choice Point.

Another application could be in assisting people as a double check to ensure that decisions they make correlate with their sense of self in situations where they believe that their judgement is clouded, for example by: emotion, sickness or fatigue.

The uses described above are based on the premise that the Subjective Genomes used to seed the system are calculated based on the individual's intention, as measured by the survey method described in PCT Patent Application Number PCT/NZ2006/000241. However, the invention could also be used with other information, for example a genome based on demographic information about the individuals. This would then show how unique a game experience is for users of different ages, or of income levels, or whatever other demographic is used to calculate the individuals' genomes.

As will be noted from the above examples, the present invention has applicability to various industries.

It will be appreciated that the invention broadly consists in the parts, elements and features described in this specification, and is deemed to include any equivalents known in the art which, if substituted for the described integers, would not materially alter the substance of the invention.

1-22. (canceled)

23. An object profile of a choice point comprising at least:
a) a set of discrete markers representing attributes of users;
b) a set of discrete buckets associated with each discrete marker representing the attribute values of users; and
c) a count associated with each bucket representing the value weighting of the choice point for that bucket,
which object profile is stored on an electronic storage device.

24. An object profile of a choice point of claim 23, wherein the choice point is selected from the group of: a material product, service, search term, URL, unique resource link, picture, an environment state, a game state, advertisement, and a user-supplied answer to a question.

25. An object profile of a choice point as claimed in claim 23 wherein the set of discrete markers comprises at least 7 discrete markers.

26. An object profile of a choice point as claimed in claim 23, wherein the set of discrete buckets associated with each discrete marker comprises at least 5 discrete buckets per discrete marker.

27. An object profile of a choice point as claimed in claim 23, wherein the set of discrete buckets associated with each discrete marker comprises at least 10 buckets per discrete marker.

28. An object profile of a choice point as claimed in claim 23, wherein the object profile is a global object profile, whereby the values of each bucket of the global object profile are the sum of the values for that bucket for all the individual object profiles for each choice point in a given system.

29. An idealised genome map for each user of an identical structure as the object profiles of claim 23, comprising at least:
a) a set of discrete markers representing attributes of users;
b) a set of discrete buckets associated with each discrete marker representing the attribute values of users; and
c) a count associated with each bucket representing the value weighting of the choice point for that bucket, which object profile is stored on an electronic storage device.

30. A method for populating an idealised genome map of claim 29 comprising the steps of:
a) retrieving a choice point selection made by the user via an input device;
b) retrieving a pre-stored object profile for the choice point from an electronic storage device, which object profile includes at least a set of discrete attributes and associated discrete values;
c) retrieving the idealised genome map for the user from an electronic storage device if it exists or creating it if it does not exist, which idealised genome map includes at least a set of discrete markers associated with a set of discrete buckets and a count associated with each bucket;
d) incrementing each count in the idealised genome map for each attribute and value in the object profile and matching marker and bucket in the idealised genome map; and
e) storing the idealised genome map on said electronic storage device.

31. A method of determining a correlation total for a relationship between an entity's profile and a choice point object profile of claim 23, including at least the following steps:
a) retrieving a choice point identification from a user via an input device;
b) retrieving a pre-stored user profile for the user from an electronic storage device, which user profile includes at least a set of discrete attributes and associated discrete values;
c) retrieving a pre-stored object profile recited in claim 23 for the choice point identification from an electronic storage device;
d) calculating a correlation total by summing each count in the object profile for each attribute and value in the user profile and matching marker and bucket in the object profile; and
e) storing the correlation total on an electronic storage device.

32. The method of claim 31, wherein the choice point identification is obtained indirectly from the user by being associated with a choice made by the user in a user interface.

33. The method of claim 31, wherein the user and the storage device are at geographically separate locations connected by a data network.

34. The method of claim 31, wherein the correlation total calculated between the entity and the choice point is compared with an expected correlation by calculating the correlation between the entity and a global object profile, whereby the values of each bucket of the global object profile are the sum of the values for that bucket for all the individual object profiles for each choice point in a given system, in order to establish a normalised correlation total between the entity and the choice point.

35. A method for populating a choice point object profile of in claim 23 including at least the steps of:
a) providing a seed user with a series of choices on a display device;
b) retrieving a choice election made by the point from the seed user via an input device;
c) creating an association with the choice election and a choice point identification;
d) retrieving a pre-stored user profile for the user from an electronic storage device, which user profile includes at least a set of discrete attributes and associated discrete values;
e) retrieving the choice point object profile from an electronic storage device for the identification if it exists or creating it if it does not exist, which object profile includes at least a set of discrete markers associated with a set of discrete buckets and a count associated with each bucket;
f) incrementing each count in the object profile for each attribute and value in the user profile and matching marker and bucket in the object profile; and
g) storing the object profile on said electronic storage device.

36. The method of claim 35, wherein the process in the above aspect is repeated for any new seed user's interacting with said choice point.

37. The method of claim 35, wherein the series of choices in a) are presented by way of URLs using an html-capable browser, wherein the choice points are related to URLs chosen by said seed user.

38. A method of determining the meaningfulness of a first set of one or more choice points as defined in claim 23 to a second set of one or more choice points as defined in claim 23 comprising:
a) retrieving a set of Average Choice Point Scores from an electronic storage device;
b) computing an overall Choice Point Set Score for said set of Choice Points by summing each Average Choice Point Score and dividing by the number of Average Choice Point Scores retrieved;
c) comparing the selected Choice Point Set Score with other Choice Point Set Scores, wherein Quantifying the meaningfulness of the selected Choice points,
where a higher Choice Point Set Score indicates more meaningfulness.

39. The method of claim 38, wherein the result is displayed on a display device or stored on an electronic storage device.

40. A method of establishing the relevance of a first set of one or more choice points as recited in claim 23 to a second set of one or more other choice points as recited in claim 23 comprising:
a) retrieving a first set of object profiles for the first set of choice points from an electronic storage device;
b) retrieving a second set of object profiles for the second set of choice points from an electronic storage device;
c) establishing the relevance of the Candidate Links to the Target Link or Links, including at least the steps of:
a. treating the Object Profiles of the Target Links as though they are Idealised Genome Maps, and obtaining an Idealised Genome for each Target Link against which the Basic Relevance Scores of the Candidate Links can be calculated; and
b. calculating the Basic Relevance Scores of the Candidate Links for the Target Links.

41. A system for determining a correlation total for a relationship between an entity's profile and a choice point's object profile as recited in claim 23 including at least the following:
a) an input device for retrieving a choice point identification from a user;
b) an electronic storage device containing at least a pre-stored user profile for the user, which user profile includes at least a set of discrete attributes and associated discrete values;
c) an electronic storage device containing at least a pre-stored object profile for the choice point identification as defined in the first aspect of the invention;
d) a calculating device for determining a correlation total by summing each count in the object profile for each attribute and value in the user profile and matching marker and bucket in the object profile; and
e) an electronic storage device for storing the correlation total.

42. A system for determining the meaningfulness of a selected choice point object profile as defined in claim 23 comprising:
a) an electronic storage device containing at least a set of Choice Point Scores from an electronic storage device;
b) computing device to compute an Average Points Score for said set of Choice Points by summing each Choice Point's Score and dividing by the number of Choice Point Scores retrieved;
c) comparing device to compute a comparison result of the selected Choice Point Score versus the Average Points Score, wherein Quantifying the meaningfulness of the selected Choice point, where a Choice Point Score that exceeds the Average Points Score indicates more meaningfulness to Users.
